(19) United States
(12) Patent Application Publication
(10) Pub. No.: US 2011/0054639 A1
(43) Pub. Date: Mar. 3, 2011

(54) METHOD FOR ENSURING SAFETY AND LIVENESS RULES IN A STATE BASED DESIGN

(76) Inventor: Luca Pazzi, Modena (IT)

(21) Appl. No.: 12/865,413

(22) PCT Filed: Feb. 1, 2008
(86) PCT No.: PCT/EP2008/051300

§ 371 Date: Nov. 16, 2010

(51) Int. Cl. G05B 9/02; G05B 11/01

(52) U.S. Cl. 700/12

(57) ABSTRACT

A method for controlling one or more physical machines for ensuring safety and liveness rules in a state based design of the physical machines, includes the steps of associating at least one logical state to at least one physical state that the physical machine or assemblage of physical machines may assume, providing state constraints for the logical states, and checking that a physical state assumed by the physical machines is associated to a logical state complying with the state constraints.

The present invention concerns a method which works upon an abstract operational and structural model of the control of one or more sets of state machines, named assemblages, by means of other state machines, named controllers. According to the model, such controllers may be further grouped into assemblages themselves and be controlled, on their turn, by other controllers, and so on.

The method is based on state constraints, which are propositions about the global state of an assemblage and enforces safety in a state based design, that is it checks that such constraints are always verified, that is when the controller is in a given state the controlled machines in the assemblage do not violate the constraint of such state. It moreover shows how to ensure that a reactive behavior is correctly implemented, that is when the assemblages moves, in an uncontrollable way, to a global state which violates the constraint of the current state of the controller, then there is a transition in the controller that is triggered and move the control out of the violated state. The method enforces also liveness in a state based design, by checking that any part of the constraint of a given state may be reached by the global state of the assemblage.

State machines

State machines as referred to in this invention are used in the control of physical machines. Such physical entities have a behavior, which is a sequence of physical states. In order to observe and control such a behavior, and therefore the machine itself, each of the physical states of the machine is converted into a logical state through a special device named sensor.

Conversely, given a set of logical states, a physical machine may be forced to move to a specific physical state corresponding to a given logical state, through a special device named actuator, that converts logical commands of a state machine into physical commands acting on a physical machine. It is also possible that a physical machine changes its state spontaneously.

The transition among the logical states is referred to as state transition. A transition among logical states in a logical machine corresponds therefore to a transition among physical states in the physical machine.

Sensor and actuators act therefore as an interface between a physical device and a computer, which manipulates indeed logical symbols. Since, as observed, there is a direct and given correspondence among physical and logical states, with related transitions among them, it is possible to use the term state machine to denote both the symbolic behavior of a device, as well as its physical counterpart.

State machines play a twofold role in a control model, since they have to represent both the behavior to be controlled as well as the behavior which exercises control over other state machines. Additionally, the two roles have to coexist in a single state machine, since controllers may be further grouped into assemblages which are controlled on their turn. The behavior of a state machine is represented by a succession of states and state transitions, originating from an initial state q₀. At each time the state machine is found in a state, named current state. State transitions take the state machine from one current state to another state and are triggered, that is activated, by either:
a direct, although non mandatory, request coming from a controller state machine;
a reaction to a specific state and behavior observed in one or more controlled state machines;

A state machine consists of an interface, which allows an external controller to observe and control the behaviour of the machine and of an implementation, which allows the machine acting as a controller to observe and control, in turn, the behavior of other state machines through their interfaces.

### State Machine Interface

A state machine interface consists of:
a set of states, among which there is a distinguished state, named initial state;
a set of logical symbols, named events, which are partitioned into two sets, respectively named input and output events;
a set of state transitions, which are directed arrows linking states, each state transition comprising:
(a) an optional state transition trigger, named external trigger, which consists of a symbol taken from the input events of the machine;
(b) an optional output symbol, which consists of a symbol taken from the output events of the machine;

The interface of a state machine is therefore formally given by:
an initial state q₀,
a finite set of states Q={q₁,q₂ . . . , q_{M}};
a finite set of state transitions T={t₁,t₂ . . . , t_{M′}} which is partitioned into two sets T₁ and T₀, which will be referred to, respectively, as input and output transitions;
a state transition function δ:Q×T→Q, such that there is a transition t from state S to state T iff δ(S,t)=T;
a finite set of identifiers E={e₁,e₂, . . . e_{K}}, named events, which is partitioned into two sets E₁ and E₀, which will be referred to as, respectively, of input and output events;
a transition labelling function event:T→E. Output transitions must be labelled by output events, and input transitions must be labelled by input events.

It is useful to define the inverse of the transition labelling function trigger⁻¹:E→2^{T}, such that, for any e∈E, trigger⁻¹(e) denotes the set of state transitions which are labelled by event e,

Input transitions are controllable through the interface, that is their activation can be requested by the controller. In any case such a request is not mandatory, that is any transition request by the controller may either succeed or not. Output transitions are instead not controllable through the interface: as such, they will also be called automatic state transitions, in the sense that they happen with no intervention from the controller. We distinguish finally a subfamily of automatic state transitions, that is (automatic) instantaneous state transition, which are taken, as their name suggests, as soon as possible.

By convention, state transitions departing from the initial state q₀ have to be automatic instantaneous state transitions and do not have to be labelled by any output event.

### State Machine Assemblages

It is useful to group state machines into assemblages A={c₁,c₂, . . . c_{M}}, which are finite set of state machines, each univocally identified within the assemblage by the distinct identifiers c₁,c₂, . . . c_{M}.

State machines within an assemblage have to exhibit a global coordinated behavior. Each state machine within an assemblage makes visible only its interface, hiding other details. We will refer to each of the cᵢ∈A as assemblage component, or more simply to as component. Components may be additionally partitioned into two classes: asynchronous and synchronous devices. Such a distinction which will have an effect on the behavior of the state machine during its interaction with a controller. Synchrony issues are discussed more thoroughly here below.

### Global State of an Assemblage

Each state machine Cᵢ belonging to an assemblage A will be found, at any time, in a state belonging to its own set of states q_{c}_{ᵢ}∈Q_{c}_{ᵢ} named the current state of cᵢ. The whole set of state machines in the assemblage A will be collectively found, at any time, in a global state q=(q_{c}_{₁},q_{c}_{₂}, . . . q_{c}_{_{M}}), with q_{c}_{ᵢ}∈Q_{c}_{ᵢ} for each Cᵢ∈A, named the current state of the assemblage A, which in turn belongs to a set Q_{A} of global states of the assemblage A given by the cartesian product of the sets of states of each device in A: Q_{A}=Q_{c}_{₁}×Q_{c}_{₂}×. . .×Q_{c}_{_{M}}.

### Assemblage Commands

Since the behavior of an assemblage has to be controlled and sensed as a whole by means of a controller, we will refer to the state transitions and to the event symbols of its component machines through unique identifiers within the assemblage. We build such a set of assemblage global identifiers by prefixing with the assemblage component name cᵢ each event symbol e∈E_{c}_{ᵢ} in the event set and each transition name t belonging to the event set of T_{c}_{ᵢ} of cᵢ. A univocally identifiable event is written as c.e, where e belongs to the set of events E_{c}while a univocally identifiable state transition is written as c.t, where t belongs to the set of transitions E_{c}, where c is the identifier of a state machine within the assemblage A.

Both the univocally identifiable event symbol c.e and transition c.t will be referred to as assemblage commands. Commands are additionally classified into the sets I_{A} and O_{A}, respectively of input and output commands depending whether the original event symbol or transition identifier belongs to the set of, respectively, input or output events and transitions, in the original component machine.

### State Machine Implementation

The implementation details of a state machine consist of additional features associated to state transitions:
an optional state transition trigger, named internal trigger, which consists of a symbol taken from the output events of a controlled machine;
an optional guard condition associated to a state transition, consisting of a logical expressions involving the states of the controlled machines;
an optional list of input events, each belonging to a controlled machine;

The implementation features of a state machine are given formally by:
a transition labelling function trigger: T→I_{A} which associates input commands to state transitions. Each input command associated to a transition, if any, is named transition internal trigger;
a transition labelling function actions: T→O*_{A} which associates a (possibly empty) list of output commands to state transitions;
a transition labelling function guard: T→ε_{A} which associates a state proposition called transition condition (also transition guard or guard condition) to a state transition. When there is no state proposition associated to a state transition, it means that the state proposition ANY_{A} (which will be shown to be always true) is by default associated to the state transition.

A state machine description may be succinctly written by a tuple:

S= [symbol] q₀Q,T,δ,E,event, I,O, trigger, actions, guard

[symbol]

An object of the present invention is to provide a method for ensuring that an assemblage of state machines does not reach a global configuration of states which may be harmful.

According to the present invention there is provided a method for controlling a physical machine or an assemblage of physical machines for ensuring safety and liveness rules in a state based design of said physical machine or assemblage of physical machines, characterized in that it comprises associating at least one logical state to at least one physical state said physical machine or assemblage of physical machines may assume, providing state constraints for said logical states, checking that a physical state assumed by said physical machine or assemblage of physical machines is associated to a logical state complying with said state constraints.

The invention will now be described, only by way of non-limitative examples, with reference to the attached drawings in which:

FIG. 1 shows an example a state machine, i.e a device, having two states, states On and Off, for instance a lamp, whose behavior can be totally controlled by means of input transitions t2 and t3 and input events on and off;

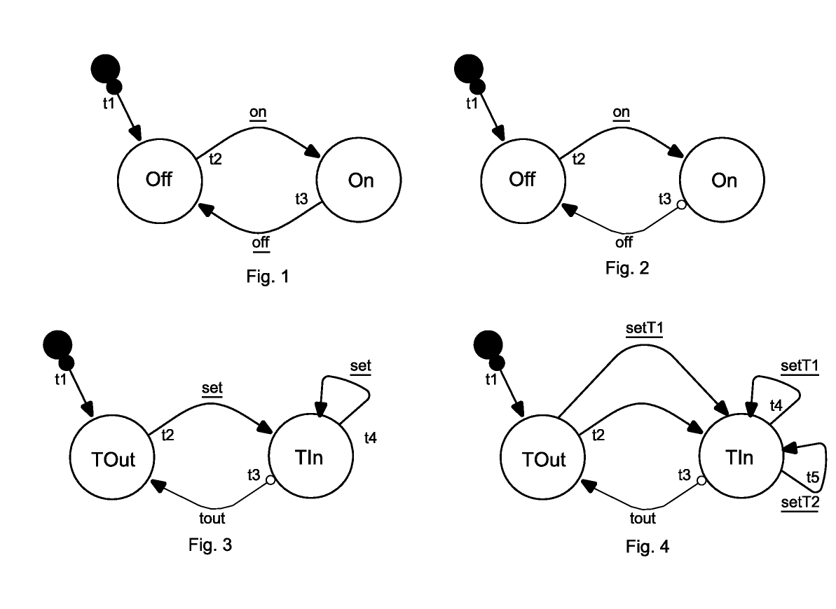

FIG. 2 shows a semiautomatic device, for instance a lamp like that of FIG. 1, whose behavior can be partially controlled by means of an input transition t2 labelled by an input event on. Transition t3 will be instead taken automatically by the machine when in state On and the output event off generated;

FIG. 3 shows another semiautomatic device, a timer, which can be used in order to implement time intervals in the behavior of more complex machines;

FIG. 4 shows another version of the device of FIG. 3, offering more input events and transitions;

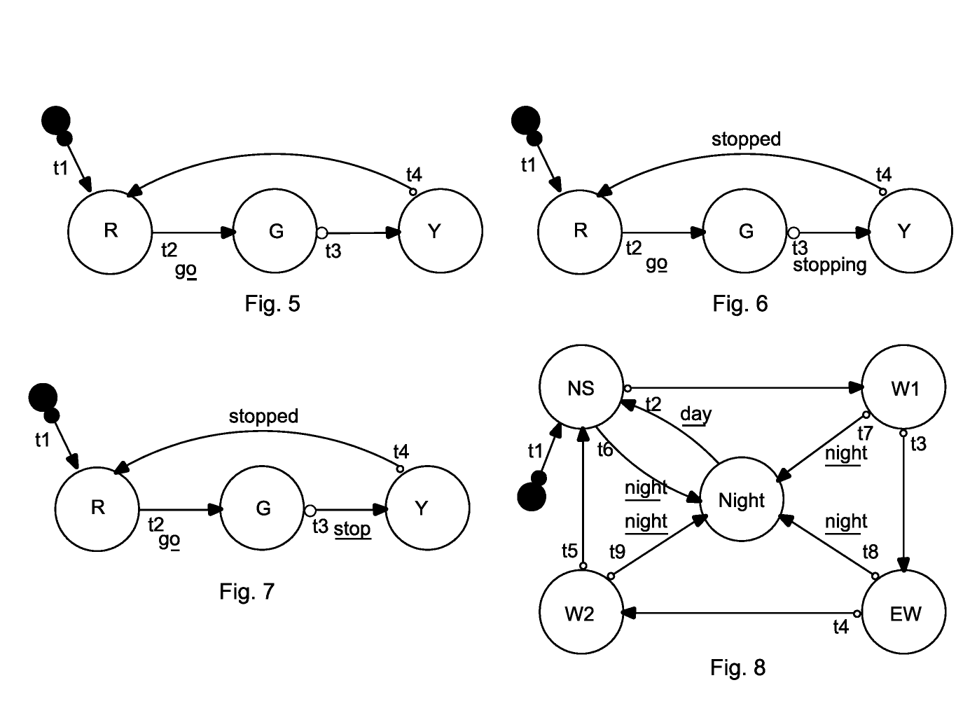

FIGS. 5 and 6 show state machines that are two versions of an implementation of a traffic light having the canonical three lamps, Red, Green and Yellow;

FIG. 7 shows a different implementation of a traffic light like that of FIGS. 5 and 6;

FIG. 8 shows an interface of a controller which coordinates the assemblage of two traffic lights of the same kind, whose interface has been shown in FIG. 6;

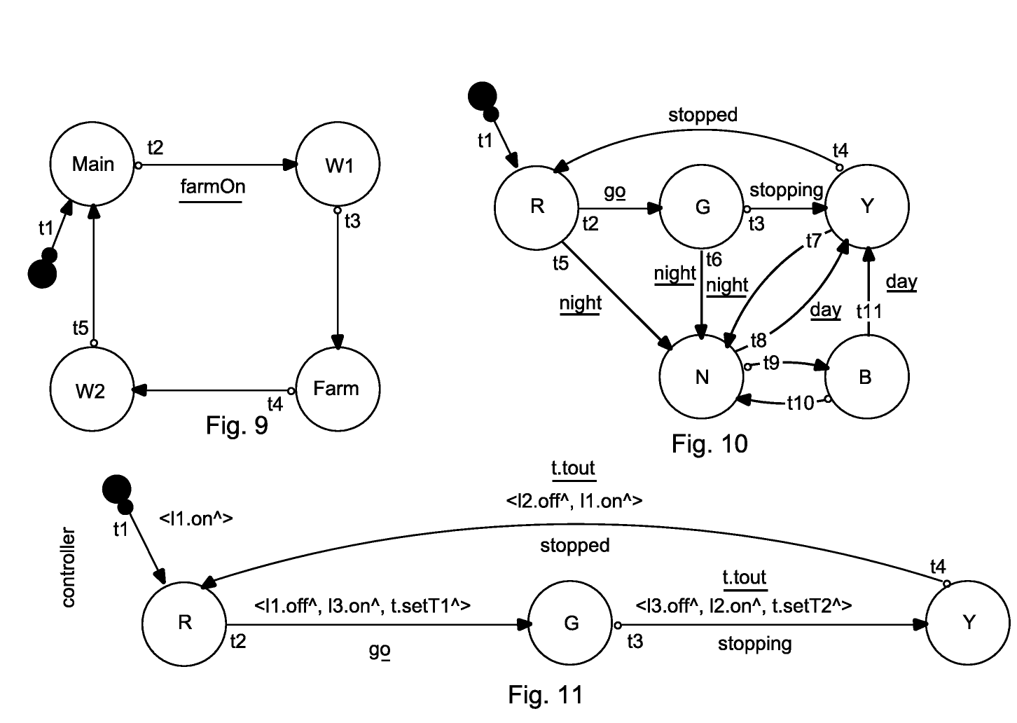

FIG. 9 shows the interface of a controller which coordinates the assemblage of two traffic lights of different kind, whose interface has been shown in FIG. 6;

FIG. 10 shows a version of a traffic light controller which implements a night mode flashing feature required by the controller of FIG. 8;

FIG. 11, 12, 13 show the implementation of two traffic light controllers given the same assemblage of state machines;

FIG. 14 illustrates pre and post condition semantics of each transition in the implementation of a traffic light controller shown in FIG. 11;

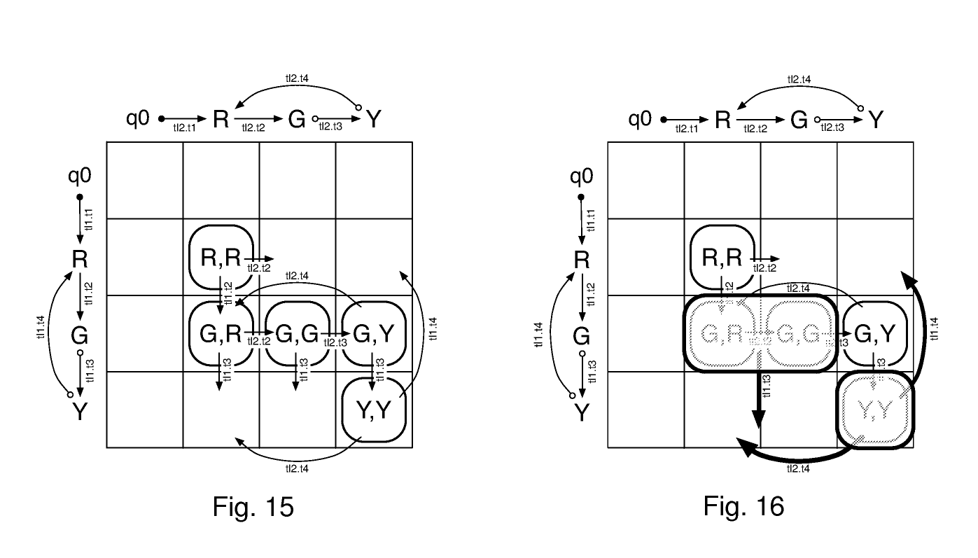

FIGS. 15 and 16 illustrates feasible state transitions associated to a fictional state proposition and the exit zones associated to a same condition;

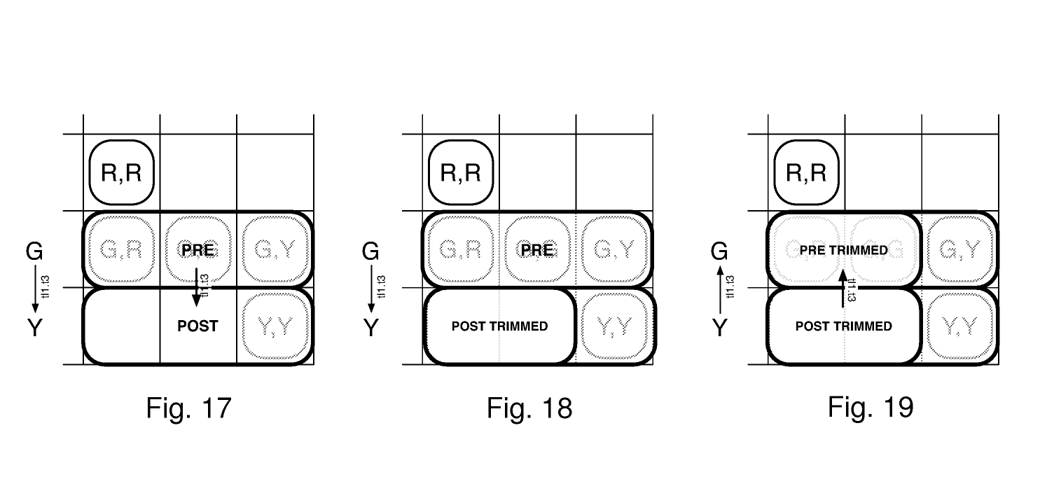

FIGS. 17, 18 and 19 illustrates a trimming process applied to the fictional state proposition of FIGS. 15 and 16;

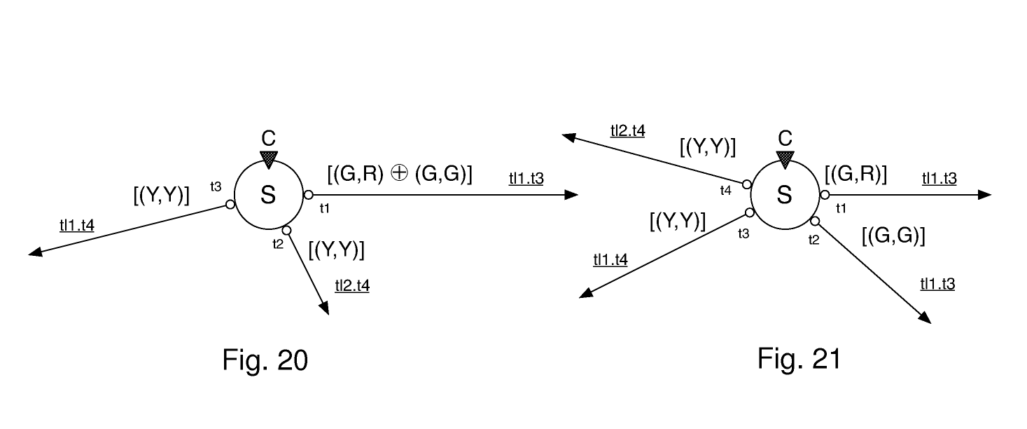

FIGS. 20 and 21 illustrate exit zones associated to a state constraint of a state of a controller;

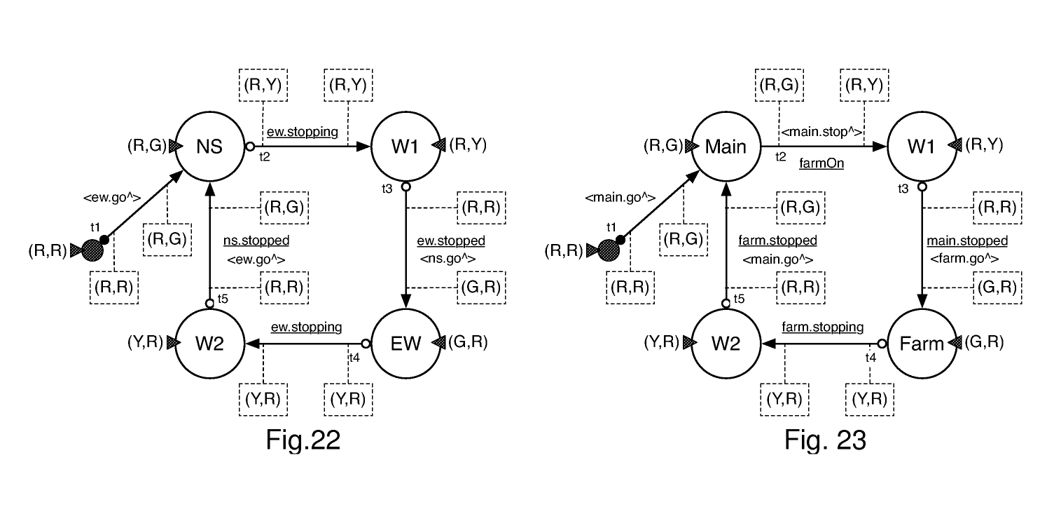

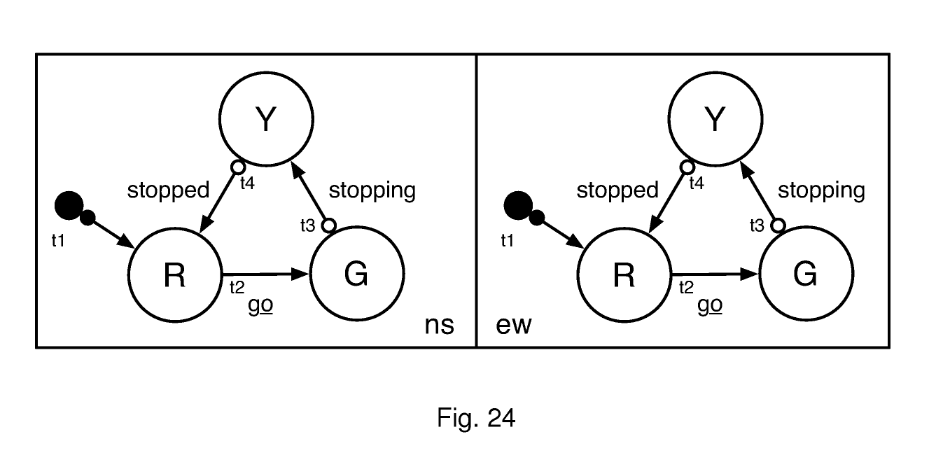

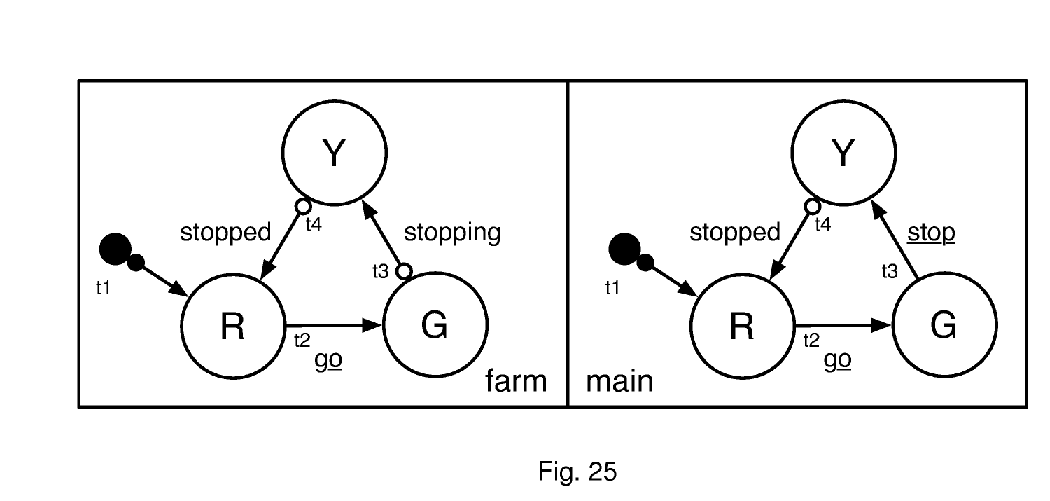

FIGS. 22 to 25 illustrate an implementation and safety verification of cross road controllers;

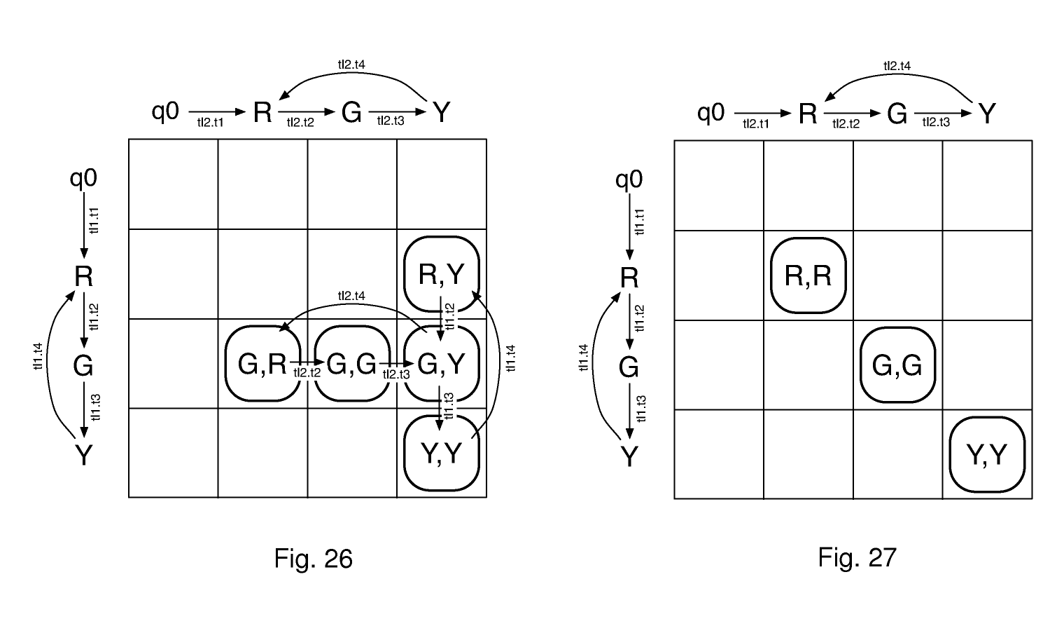

FIGS. 26 to 29 illustrate four examples of assemblage propositions;

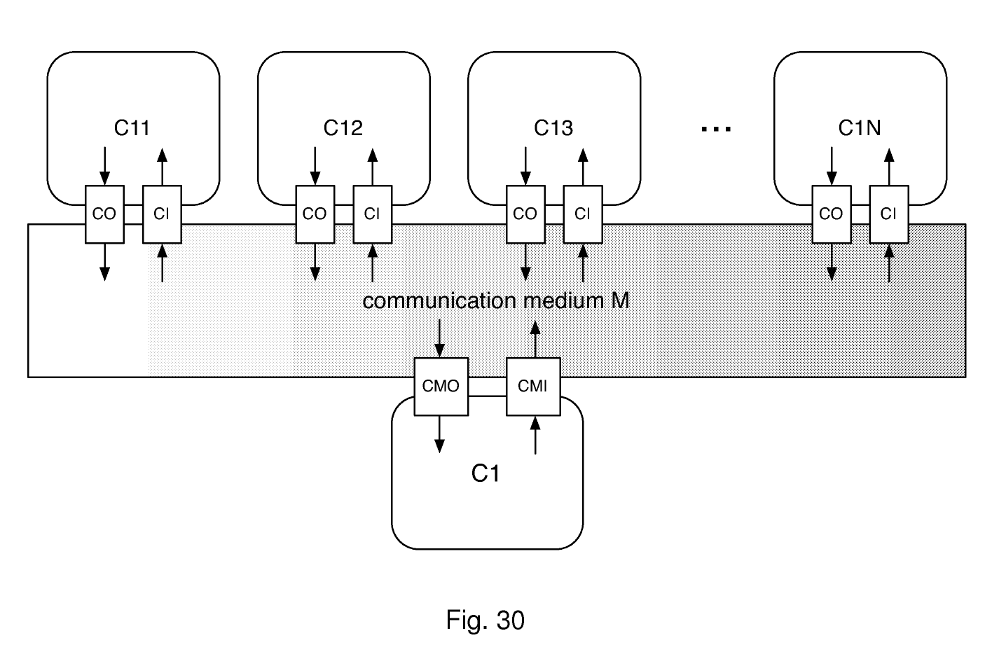

FIG. 30 illustrates a single level architecture involving an assemblage of component state machines;

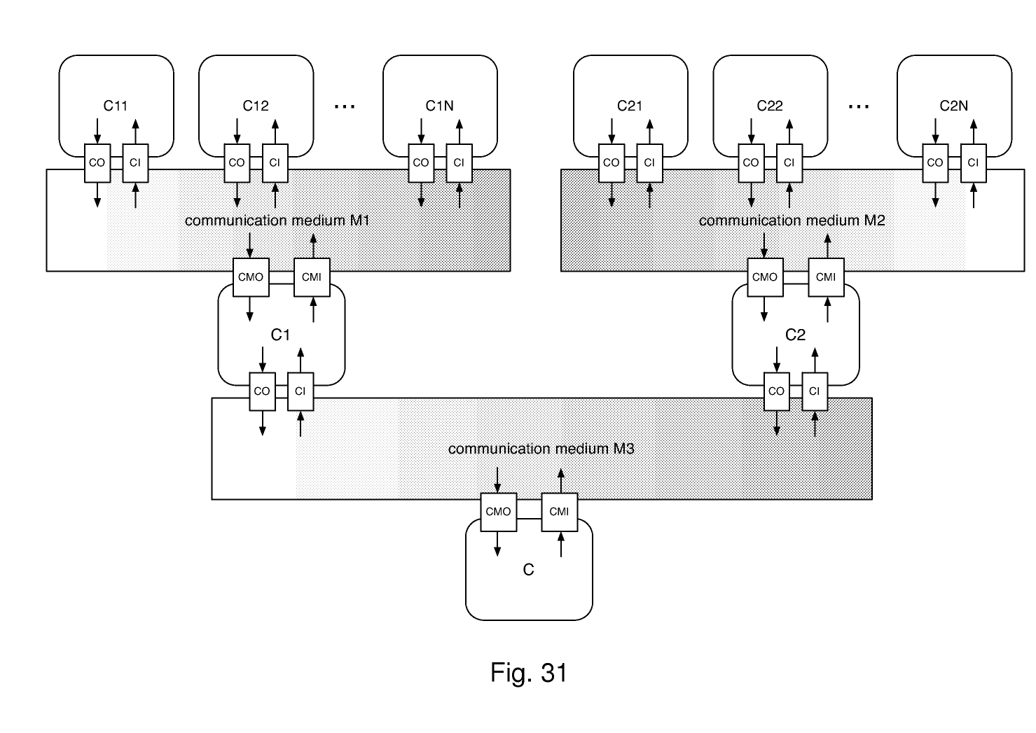

FIG. 31 illustrates a multilevel architecture involving an assemblage of component and controller state machines;

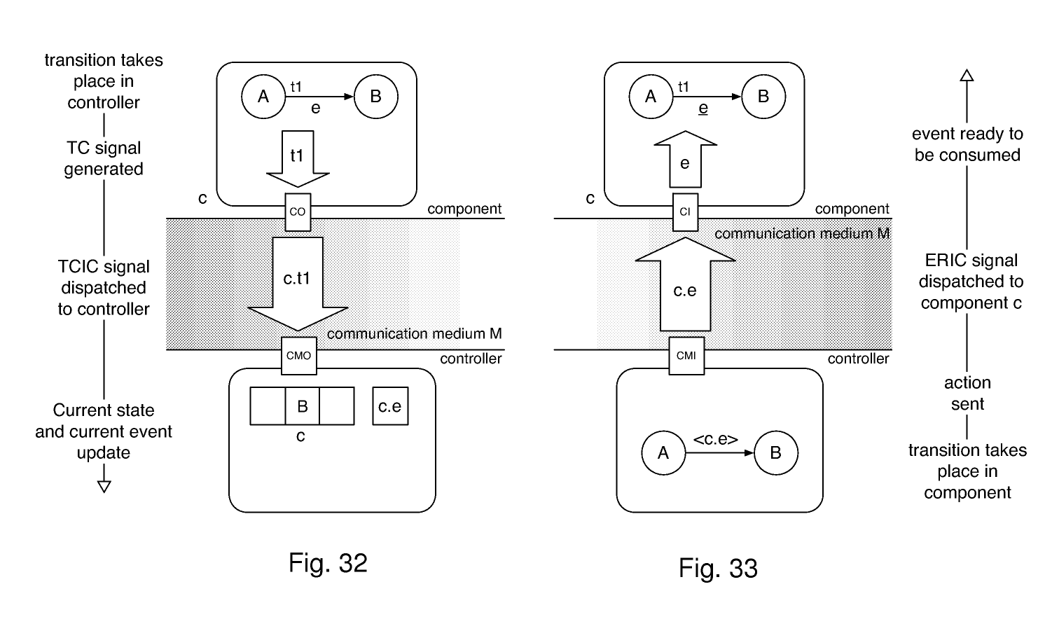

FIG. 32 illustrates a communication flow controller-component;

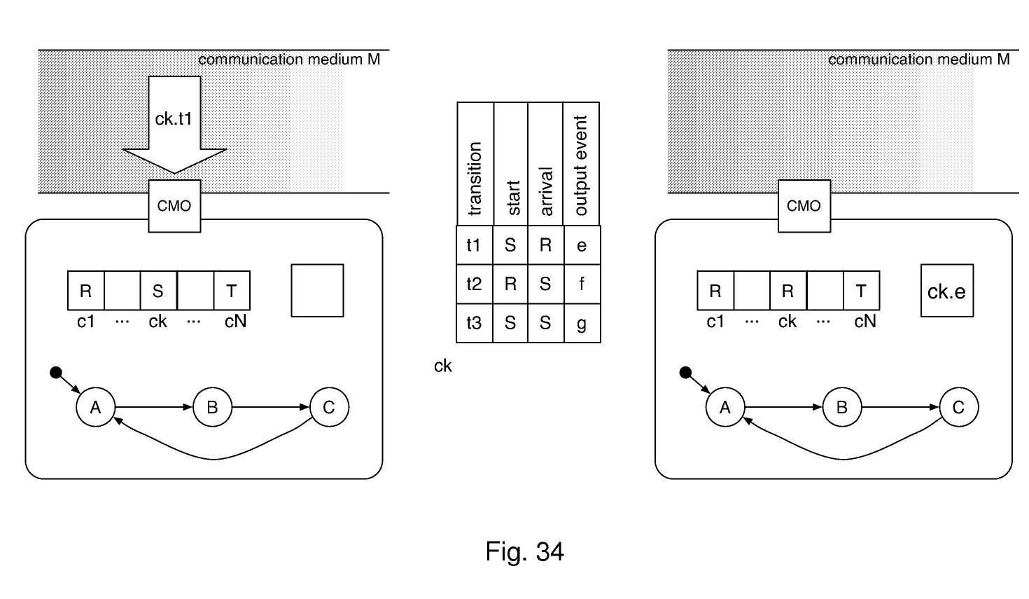

FIG. 33 illustrates a communication flow component-controller;

FIG. 34 illustrate a current state array and incoming event computation.

FIGS. 1 to 10 illustrate examples of state machine interfaces.

In FIGS. 1 to 10 the following graphical conventions have been adopted: state machine interfaces are drawn as directed graphs, where input transitions are drawn as arrows, output automatic transitions are drawn as arrows which have a small white circle in correspondence of the transition initial state and an arrow in correspondence of the arrival state; finally, instantaneous state transition are distinguished from the other automatic transition by painting black the small circle.

Input events are underlined. State transition identifiers are drawn close to the beginning of the arrow, while input and output events are drawn instead near the middle of the arrow. The initial state q₀ is finally drawn as a black dot.

The meaning of boolean algebra operators and expressions used in the rest of this description is explained at paragraph “The boolean algebra of assemblage expressions” and subsequent paragraphs here below.

FIGS. 1 to 4 illustrate examples of state machines to which the method according to the invention may be applied.

FIG. 1 shows an example a state machine, i.e a device, having two states, states On and Off, for instance a lamp, whose behavior can be totally controlled by means of input transitions t2 and t3 and input events on and off.

FIG. 2 shows a semiautomatic device, for instance a lamp like that of FIG. 1, whose behavior can be partially controlled by means of an input transition t2 labelled by an input event on. Transition t3 will be instead taken automatically by the machine when the machine is in state On and the output event off is generated.

FIG. 3 shows another semiautomatic device, a timer, which can be used in order to implement time intervals in the behavior of more complex machines. A timer starts and rests in the TOut state, until it is forced to move to the TIn state by the controllable (input) transition t2 on the receipt of the input event Set. It then remains in the TIn state for a definite and fixed amount of time, that is until the automatic (output) transition t3 is taken and the corresponding (output) event tout is generated. A self loop is provided by the input transition t4 which starts and ends in the state TIn, meaning that, when the timer is in state TIn and the input event is received by the machine, then the measurement of the time interval is restarted.

FIG. 4 shows another version of the device of FIG. 3, offering more input events and transitions, namely setT1 and setT2, each meaning that a different time interval has to pass before the timer returns to the timeout state.

FIGS. 5 and 6 show state machines that are two versions of an implementation of a traffic light having the canonical three lamps, Red, Green and Yellow.

Referring to FIG. 5, each of said lamps, once lit, corresponds to the three states of the state machine, respectively state R, G and Y. Both of the two versions of the traffic light controller have an input/controllable transition t2 labelled by the input event go and two automatic output transitions, which happen automatically. Such a device is then controlled by a go event, after that it cycles automatically (by taking automatic transitions t3 and t4) through the other two states until it returns to the R state.

FIG. 6 shows a more readable version of the traffic light controller, which emits output events stopping and stopped when the two automatic transitions are taken.

FIG. 7 illustrate a different version of the traffic light controller since it rests in the R state until a stop command is issued through the input event stop.

FIG. 8 shows the interface of a controller which coordinates the assemblage of two traffic lights of the same kind, whose interface has been shown in FIG. 6.

The two traffic lights are placed on the crossing of two roads, one running from North to South and the other from East to West. The controller has four states: state NS, which means that the road traffic is enabled from North to South and vice versa, state W1, which means that traffic is being stopped in such a road, state EW, which means that the road traffic is enabled from East to West and vice versa and finally state W2, which means, as in the other case, that traffic is being stopped in such a road. The basic cycles happens automatically. A different working mode, corresponding to state Night (both the roads have yellow flashing light), may be reached by issuing a command through the input event night when the state machine is in any state of the basic cycle. From the night mode it is possible to restart the basic cycle starting from the NS state, by issuing a command through the input event day.

FIG. 9 shows the interface of a controller which coordinates the assemblage of two traffic lights of different kind, whose interface has been shown in FIGS. 6 and 7, which are placed, respectively, on a main road ad on secondary farm road.

The controller starts on the Main state, meaning that the traffic on the main road is enabled to flow and the farm road is stopped, and it rests on such state until a command is issued to the controller through the event farm. The controller then moves automatically to state W1, where the main road is stopping and the farm road is still blocked, then to the state Farm, where the traffic on the farm road is enabled to flow and the main road is stopped. After some fixed time interval the controller moves automatically to state VV1, where the farm road is stopping and the main road is still blocked, and to the Main state again, where it rests waiting for the next command.

FIG. 10 shows finally a version of the traffic light controller which implements the night mode flashing feature required by the previous cross road controller of FIG. 8. Such a feature is realized by two additional states, N and B, respectively having the yellow lamp lit and no lamp lit, which alternate themselves in order to obtain the flashing mode. By the input events night and day it is possible to switch from the regular cycle mode to the flashing mode, and back.

FIGS. 11 to 13 shows the implementation of the two controller state machines whose interface has been shown in FIGS. 6 and 7 by using an assemblage of four synchronous state machines, that is three lamp state machines, identified by I1, I2 and I3 whose interface is depicted in FIG. 1 and the timer state machine, identified by t, whose interface is depicted in FIG. 4.

The following graphical conventions are adopted: state machines are drawn as directed graphs and retain all the details of the interface.

Guard conditions are enclosed in square brackets and drawn near the beginning of the arrow, internal triggers are underlined and command lists are enclosed in angular brackets. The default state proposition guard ANY_{A} is by convention not drawn.

Actions in the action list which are directed towards assemblage synchronous components are distinguished by postponing an upper arrow to the command.

Finally, when it is shown, the controlled assemblage is drawn by reporting the component state machines above a dotted line, each identified by the assemblage identifier and separated by a solid line (as in FIGS. 11 to 13).

### State Transition Typologies

Internal and external features of state transitions can not be arbitrarily mixed. The following rules must be followed, dictated by the rationale that it is not possible to specify both an internal trigger and an external trigger for a single state transition.

State transitions can be thus classified into three families:

internally triggerable state transitions, which have an internal trigger, instantaneous state transitions, which have no triggers at all and externally triggerable state transitions, which have an external trigger; such a classification very easily maps to the interface distinction amongst controllable and automatic (non controllable) transitions:

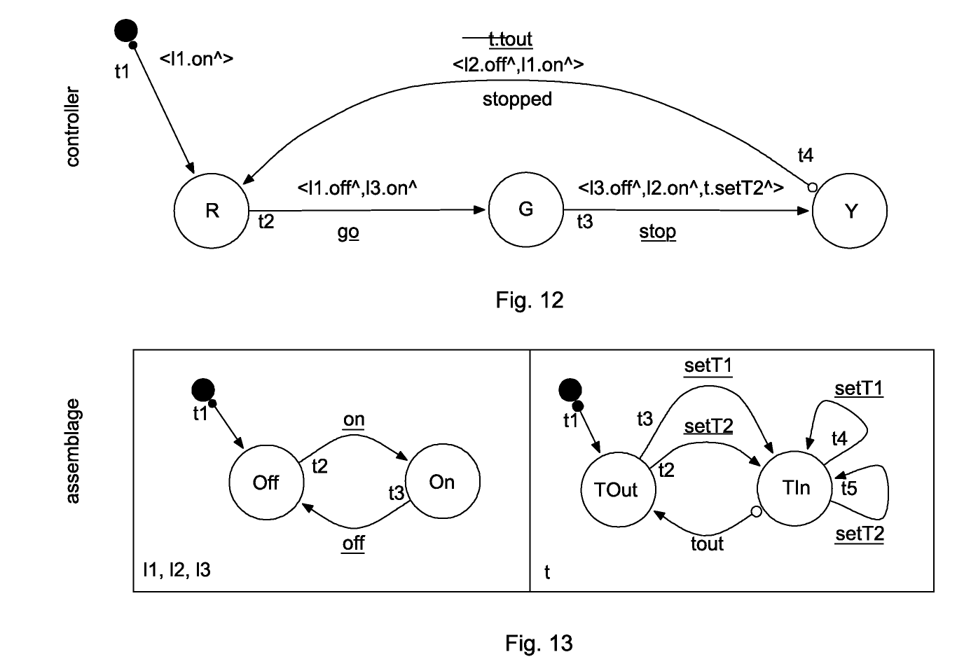

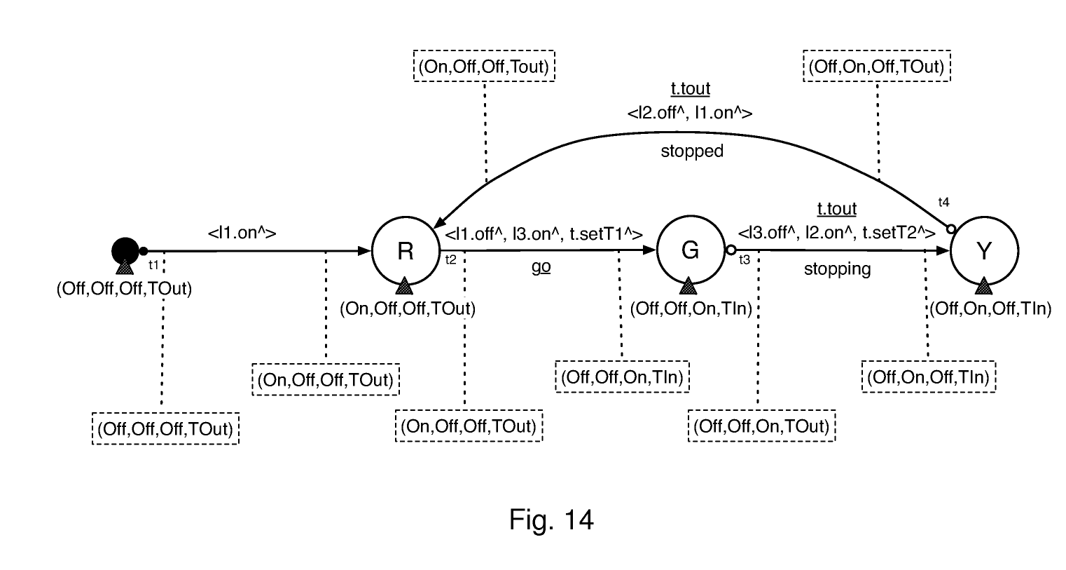

Internally triggerable state transitions are those which react to changes in the controlled machines. An example is given in FIG. 11 by transitions t₃ and t₄ and in FIG. 12 by transition t₄. Internally triggerable state transitions give rise to automatic transition when the state machine is seen through its interface.

Instantaneous state transitions are those which do not specify any trigger, hence are taken as soon as their guard condition becomes true. An example is given in FIGS. 11 and 12 by transition t₁, which is triggered instantaneously and in any case it is guarded by the state proposition ANY_{A} which is always true and is not drawn by convention. They give rise to automatic instantaneous transition when the state machine is seen through its interface.

Externally triggerable state transitions are those which react to commands sent to the interface of the machines. An example is given in FIG. 11 by transition t₂ and in FIG. 12 by transitions t₂ and t₃.

By comparing the interface of the controller in FIG. 2 and its implementation in FIGS. 11 to 13 it is clear that a state machine interface can be obtained from its implementation; vice versa it is possible to design the behavior by specifying its interface and then specify its implementation accordingly.

The method that is the object of the present invention will now be described in detail.

### Verification Method

It is important to ensure that an assemblage of state machines does not reach a global configuration of states which it may be harmful.

The problem regards in general having full knowledge about the configuration of states which an assemblage of state machine can assume. According to the method of the present invention it is possible to design a controller in such a way that the controlled assemblage is always under such a control. By this method it is possible both to ensure that an assemblage of state machine does not reach a forbidden configuration as well as that any allowed configuration of states may be reached by the assemblage.

### State Constraints

The method according to the invention works by first associating to each state S of the controller an assemblage state proposition, which is a formula which denotes the exact set of states that the modeler wants to be assumed by the assemblage when the controller is in a state S. Such a state proposition is named state constraint and denoted by vinc(S).

### State Transition Precondition Semantics

State transitions denote a set of global states in which the assemblage must be found in order for the state transition to be taken. Such set of states is denoted by a state proposition which is called precondition semantics. It can be computed according to the features of the transition and to the different typologies in which it may be classified:
externally triggerable transition: let t be a transition originating from a state S of the controller constrained by state proposition vinC(S). Necessary condition for state transition t to be executed is that its guard condition guard(t) holds, that is, the assemblage must be in state q such that q satisfies guard(t). Since, at the same time, the state transition t originates from S we have that q has necessarily to be contained within the maximal set of states the assemblage may assume when the controller is in S, that is q satisfies vinC(S). The precondition semantics pre(.) of state transition t, guarded by state proposition c, is then given by the intersection of the transition guard and of the state constraint of the state from which the transition originates:

pre(t)=guard(t)⊙vinc(S)
internally triggerable transition: let t be a transition originating from a state S of the controller constrained by state proposition vinC(S) and triggered by transition t in component c. As in the case above, necessary condition for state transition t to be executed is that its guard condition guard(t) holds, that is, the assemblage must be in state q such that q satisfies guard(t). Since, at the same time, the state transition t originates from S we have that q has necessarily to be contained within the maximal set of states the assemblage may assume when the controller is in S, that is q satisfies vinc(S) after either a triggering transition c.t happened within the assemblage or the triggering command c.e is received from the assemblage. Two cases then arise:

(a) In the former case we know that such a state transition happened and therefore the state proposition vinc(S) has been transformed into transf(vinc(S),c,t), where transf(vinc(S),c,t) is a state proposition p′ which means “the assemblage was in a state p and a state transition t happened. The precondition semantics pre(.) is therefore in this case given by:

pre(t)=guard(t)⊙transf(vinc(S),c,t) (2)

(b) In the latter case we know that a command of the kind c.e may have triggered any of the transitions which have e as input trigger. We have therefore that the state proposition vinc(S) has been transformed into transfE(vinc(S),c.e), where

$$transfE ( vinc ( S ) , c . e ) = {⊕}_{t ∈ T} transf ( vinc ( S ) , c , t ) ,$$

T being the set of transitions that are triggerable by event e in component c, in symbols T=trigger⁻¹ (e).

The precondition semantics pre(.) is therefore in this case given by:

pre(t)=guard(t)⊙transfE(vinc(S),c.e) (3)
instantaneous transitions: as in the case of externally triggerable transitions, the precondition is then given by the intersection of the transition guard and of the state constraint of the state from which the transition originates, hence the precondition semantics pre(.) is given by Equation 1 above.

It may be observed that a state transition such that pre(t)=NONE_{A} will never be executed, hence it may be removed from the state diagram. It may be further observed that, necessary condition in order to have at most one external transition chosen for execution on the receipt of a triggering event e, if T(e,S)is the set of external transitions having S as starting state and e as trigger, for any t₁,t₂∈T(e,S) than pre(t₁) and pre(t₂) must be disjoint. We observe, finally, that, in order to have exactly one external transition taken on the receipt of e, the set of the transition preconditions in T(e,S) must form a partition of C(S).

### EXAMPLE 1

### Calculation of Precondition Semantics

In this example the semantic precondition of the transitions of the two versions the traffic light controller implementation shown in FIGS. 11 and 12 are calculated.

1. First controller (FIG. 11):

A constraint is first assigned to each of the four states of the controller:

(a) vinc(q₀)=ON₌^{I1}⊙Off₌^{I2}⊙Off₌^{I3}⊙TOut₌^{t}

(b) vinc(R)=On₌^{I1}⊙Off₌^{I2}⊙Off₌^{I3}⊙TOut₌^{t}

(c) vinc(G)=Off₌^{I1}⊙Off₌^{I2}⊙On₌^{I3}⊙TIn₌^{t}

(d) vinc(Y)=Off₌^{I1}⊙On₌^{I2}⊙Off₌^{I3}⊙TIn₌^{t}

We have that t₁ is an instantaneous transition starting from Q₀: we have therefore to compute its precondition according to Equation (1):

pre(t₁)=vinc(q₀)⊙guard (t₀)=On₌^{I1}⊙Off₌^{I2}⊙Off₌^{I3}⊙TOut₌^{t}

We have that t₂ is an externally triggered transition, hence its precondition is again calculated through Equation (1):

pre(t₂)=vinc(R)⊙guard (t₀)=On₌^{I1}⊙Off₌^{I2}⊙Off₌^{I3}⊙TOut₌^{t}

The next three transitions are instead internally triggered by an assemblage state transition, hence, it is necessary to calculate the transformation induced on the respective starting state constraint by such transition. We have then that their precondition semantics is therefore given by Equation (2):

pre(t₃)=transf(vinc(G),t,tout)⊙guard(t₃)=Off₌^{I1}⊙Off₌^{I2}⊙On₌^{I3}⊙TOut₌^{t}

pre(t₄)=transf(vinc(Y),t,tout)⊙guard (t₃)=Off₌^{I1}⊙On₌^{I2}⊙Off₌^{I3}⊙TOut₌^{t}

2. Second controller (FIG. 12)

We assign first a constraint to each of the four states of the controller:

(a) vinc(q₀)=On₌^{I1}⊙Off₌^{I2}⊙Off₌^{I3}⊙TOut₌^{t}

(b) vinc(R)=On₌^{I1}⊙Off₌^{I2}⊙Off₌^{I3}⊙TOut₌^{t}

(c) vinc(G)=Off₌^{I1}⊙Off₌^{I2}⊙On₌^{I3}⊙TOut₌^{t}

(d) vinc(Y)=Off₌^{I1}⊙On₌^{I2}⊙Off₌^{I3}⊙TIn₌^{t}

We have then that t₁ is an instantaneous transition starting from q₀: we have therefore to compute its precondition according to Equation (1):

pre(t₁)=vinc(q₀)⊙guard(t₀)=On₌^{I1}⊙Off₌^{I2}⊙Off₌^{I3}⊙TOut₌^{t}

We have that, in this case, both t₂ and t₃ are externally triggered transition, hence its precondition is again calculated through Equation (1):

pre(t₂)=vinc(R)⊙guard(t₀)=On₌^{I1}⊙Off₌^{I2}⊙Off₌^{I3}⊙TOut₌^{t}

pre(t₃)=vinc(G)⊙guard(t₀)=Off₌^{I1}⊙Off ₌^{I2}⊙On₌^{I3}⊙TOut₌^{t}

The last transition is instead internally triggered by an assemblage state transition, hence, it is necessary to calculate the transformation induced on the respective starting state constraint by such transition. We have then that its precondition semantics is given by Equation (2):

pre(t₄)=transf(vinc(Y),t,tout)⊙guard(t₃)=Off₌^{I1}⊙On₌^{I2}⊙Off₌^{I3}⊙TOut₌^{t}

### State Transition Postcondition Semantics

Let t be a transition in the controller having a list of associated actions l=actions(t). When the transitions is started, the assemblage is in any global state Q which satisfies pre(t). When the state transition is executed, each action directed towards a synchronous component of the assemblage modifies such a state q before the state transition ends its execution. Let Q′ be the state of the assemblage after the last action is executed. When the state transition is terminated the assemblage is therefore found in a global state q′, which satisfies the state proposition originating from the precondition pre(t) of the transition transformed by the occurrence of the list of actions, let it be called postcondition semantics post(,) then given by:

post(t)=transfL(pre(t),lₛ) (4)

Where lₛ is the sublist of l containing only actions directed towards synchronous components and transfL(•,•) is the function which transforms a state proposition according to a list of actions, which will be defined later.

### EXAMPLE 2

### Calculation of Postcondition Semantics

Referring now to FIG. 14, we calculate the postcondition semantics of the four transitions of the first traffic light controller example of FIG. 11; in all cases we simply transform the precondition semantics previously calculated in Example 1 by the operator transfL (•,•) given the list of commands that label each transition. We have therefore that: post (t₁)=transfL(pre(t), [symbol] )=On₌^{I1}⊙Off₌^{I2}⊙Off₌^{I3}⊙TOut₌^{t} where the precondition semantics is: pre(t₁)=On₌^{I1}⊙Off₌^{I2}⊙Off₌^{I3}⊙TOut₌^{t} In other words, since state transition t₁ is labelled with no commands, post and precondition semantics are the same.

post (t₂)=transfL(pre(t₂), [symbol] 1.off↑,I3.on↑,t.setT1| [symbol] )=Off₌^{I1}⊙Off₌^{I2}⊙On₌^{I3}⊙TIn₌^{t}

where pre(t₂)=On₌^{I1}⊙Off₌^{I2}⊙Off₌^{I3}⊙TOut₌^{t}

In other words the effect of the commands I1.off↑, I3.on↑ and t.SetT1↑is, respectively, to turn off lamp I1, to turn on lamp I3 and to set the timer t1 to state Tin. Since the three commands are synchronous, their effect is achieved before the end of the controller transition. We calculate accordingly the semantics of the last two state transitions:

post(t₃)=transfL(pre(t₃), [symbol] 3.off↑,I2.on↑,t.set T2↑ [symbol] )=Off₌^{I1}⊙On₌^{I2}⊙Off₌^{I3}⊙TIn₌^{t}

where pre(t₃)=Off₌^{I1}⊙Off₌^{I2}⊙On₌^{I3}⊙TOut₌^{t};

post(t₄)=transfL(pre(t₄), [symbol] I1.on↑,I2.off↑ [symbol] )=On₌^{I1}⊙Off₌^{I2}⊙Off₌^{I3}⊙Tout₌¹ where

pre(t₄)=Off₌^{I1}⊙On₌^{I2}⊙Off₌^{I3}⊙TOut₌^{t}.

### State Transition Semantic Safety

A state transition t ending in a state T of the controller is said to be semantically safe iff:

post(t) [symbol] ε_{A}vinc(t) (8)

### EXAMPLE 3

It can be easily checked that in all four cases the postcondition semantics for the four transitions of the example presented in FIGS. 11 to 13 satisfy Equation above. Hence the implementation of the state transitions is safe.

### Feasible Transitions Associated to a State Proposition

The feasible transitions associated to a state proposition C are the set of transitions that can be taken by the component machines of the assemblage when the system is in any global state that satisfies C and can be found by Algorithm 1 shown here below, which examines all the state transitions in all the state machine of the assemblage, determines for each of such transitions the respective starting state, then checks the proposition which states that the assemblage is in such starting state and at the same time in C: if such proposition is true the transition is added to the set of feasible transitions.

Algorithm 1: Feasible Transitions Algorithm

```
input: An assemblage of state machines A and an assemblage
proposition C
output: The set F of feasible state transition of A under C
foreach state machine c in the assemblage do
    foreach transition t in c do
        take the start state of the transition, say S;
        form the state proposition p = “state machine c is
        in state S”;
        compute the state proposition p⊙C;
        if p⊙C is not empty then
            add transition t to the set F;
        end
    end
end
```

The set of feasible state transitions F can be further partitioned into two sets, F₀ and F₁, respectively of output and input feasible transitions, by trivially examining whether they belong, respectively, to the set T₀ or T₁ of output and input transitions of the state machine to which they belong. F₀ is called also the set of feasible non controllable transitions associated to C.

### Notation

We write (X, Y) for the state proposition X₌^{c1}⊙Y₌^{c2} which denotes a single global state, once the assemblage having components C1 and C2 is known from the context.

### EXAMPLE 4

Let Cross be an assemblage composed by a pair of a traffic light of the kind depicted in FIG. 1. Since each component state machine has four states, the whole assemblage may be found in sixteen states, which are depicted in FIGS. 15 and 16, where traffic light states are laid linearly, together with the existing transitions, which can distinguished among controllable or not controllable by the graphical symbology used so far. Consider the totally fictional assemblage proposition traffic light 1 is in state Green and traffic light 2 is not in state q0 or traffic lights are both in state Red or both in state Yellow, which can be written as C=(((G₌^{tI1}⊙ [symbol] q0₌^{tI2})⊕(R₌^{tI1}⊙R₌^{tI2}))⊕(Y₌^{tI1}⊙Y₌^{tI2})). State proposition C can be easily shown to be satisfied by any of the global states depicted as round squares in FIG. 15, which also depicts the transitions which start from such states, that is the set of feasible transitions F associated to state proposition C. It can be observed that in some cases a transition leads to a state which still satisfies proposition C, while in other cases it does not. For example two transitions can be taken when the assemblage is in the global state (R, R), namely transition tI2.t2 which leads to state (R, G), which does not belong to proposition p and transition tI1.t2 which leads to state (G,R), which belongs instead to proposition p.

### Exit Zones

Given a state proposition C, there exist subpropositions of C such that, when the assemblage is within one of such subpropositions, there are non controllable transitions such that, if and when taken, move the assemblage to a global state such that C is no more satisfied. Such subpropositions are called “exit subpropositions” and play an important role in detecting when a state constraint may be violated. Given in fact a proposition C, we are interested in finding all the couples (p,t), where p is an exit subproposition and t is the non controllable transition, named “exit transition”, that takes the assemblage out of C when the assemblage is in p. Algorithm 2 shown here below finds all the exit zones associated to a state proposition C given the set F₀ of feasible non controllable transitions associated to C. The algorithm works by forming, for each state transition t in F₀, the state proposition pre=“state machine c is in the start state of t and satisfies C”, then transform it according to the transition t. The resulting state proposition, named post=“state machine c was in the start state of t and satisfied C then state transition t happened”, may be only partially outside of the original proposition C, then it is trimmed, that is the state predicate postTrimmed=“the assemblage satisfies post and does not satisfy C” is calculated. By reversing the direction of state transition t and by transforming postTrimmed according to such reversed transition, we found the proposition preTrimmed, which is the larger subproposition of pre such that: the assemblage is in a global state which satisfies pre and the happening of t brings the assemblage in a global state such that C is no more satisfied.

Algorithm 2: Exit Zones Algorithm

| | |
|---|---|
| input: | The set Fₒ of feasible non controllable state |
| | transition of assemblage A under proposition C |
| output: | The set Ez of exit zones associated to C |

```
foreach transition t in the set Fₒ do
    take the start state of transition t, say S;
    form the state proposition p = “state machine c is in
    state S”;
    compute the state proposition pre = p⊙C;
    transform the state proposition pre according to t, let
    it be post;
    compute state proposition postTrimmed = post⊙ [symbol] C;
    if postTrimmed is not empty then
        transform postTrimmed according to t reversed, let
        it be preTrimmed;
        add (preTrimmed, t) to the set Ez of exit zones of
        the assemblage;
    end
end
```

### Exit Zone Coverage

An exit zone (p,tₖ) associated to a state constraint C of a state S of the controller is said to be covered iff there exists in the controller a set of internally triggerable state transition T_{S} such that each transition t in T_{S} has state S as start state, is triggered by tₖ and the set of preconditions of the transitions in T_{S} forms a partition of p.

### State Safety

The method ensures that, if all the state transitions in the controller are semantically safe and if each exit zone in the diagram has been covered by a state transition set in the controller then the following proposition holds:

### Proposition 1 (State Safety Invariant)

When the controller is in any state S, the assemblage is in a state q which satisfies vinc(S).

The truth of the proposition above can be inductively checked by ensuring that
it is true in the initial state of the controller;
it is true after any state transition in the controller; we have in fact that if the controller moves from state R to S by transition t, and if the state transition t is semantically correct, then the Proposition 1 above is verified since the postcondition semantics is included within the constraint of T;
it is true after any state transition in the assemblage; In this case, either the state of the assemblage after the transition still satisfies the constraint for the state in the controller or it does not. In case it does not satisfies such constraint for the state, the assemblage transition necessarily originates from an exit subproposition of the constraint and the transition has therefore been previously classified as an exit transition. Since any exit zone has been covered by a state transition in the controller, a state transition, say tk, will be triggered and move the current state of the controller to another state of the controller, say T. Since the postcondition of tk is such that it satisfies the constraint of state T (observe that T may also coincide with S), the state safety invariant enounced above holds in this case also.

### Atomic Proposition

Given any current state q of the assemblage A it is possible to form the state proposition “assemblage A is in global state q”. Such a state proposition is called the atomic state proposition associated to global state q. When it is clear form the context and no ambiguity arises, we use the notation q to denote both the assemblage global state as well as the associated atomic proposition.

### Connected Atomic Propositions

Given two assemblage atomic state propositions p and q, we say that they are connected iff there exist an assemblage transition, say c.t, such that p is transformed in q by c.t, in symbol q=transf (p, c, t)

### State Liveness

By state liveness we mean that:

1. any state in the controller must be externally reachable, that is there must be a path of state transitions from the initial state qₒ to any state S in the controller;

2. any atomic subproposition p of the state semantics vinc(S) of each externally reachable state S of the controller must in turn be internally reachable by the global state of the assemblage, that is, there must exists a path of assemblage state transitions from any subproposition of post(t) to subproposition p, where t is one of the incoming transitions to state S.

A state proposition is made of parts, that is subpropositions of the main state proposition, which are in general not connected, that is it does not exist any assemblage transition, either controllable or not, such that the assemblage current state will move from a subproposition to another. That means that some parts of the state constraint may not be reachable, and therefore, even if the state constraint is not violated, some expected properties may not be satisfied (safety and liveness are indeed orthogonal concepts).

In order to ensure that any part of a state proposition be reachable, control to each isolated part must be brought directly by different state transition of the controller. It may be observed that the state semantics vinc(S) may be viewed as a set of directed graphs made of subproposition arranged as Strongly Connected Components (SCC). Any atomic proposition within a SCC is such that it is reachable by any other atomic proposition within the same SCC. An atomic subproposition is itself a SCC. SCCs may be connected, and in such a case the resulting graph is acyclic, since if there were a cycle among two directed SCCA, then any atomic proposition in the former will be reachable from atomic proposition in the latter, and the two SCCs will become, by definition, a single SCC. Any state proposition can be therefore seen as a set of directed graphs having SCCs as nodes and assemblage state transitions as arcs. Any direct graph has one or more sources, that is elements of the digraph such that that there are not incoming arcs. Starting from the sources of a graph it is possible to reach any other part of the graph.

In order therefore to reach all the subpropositions of a state proposition, like the semantics vinc(S) of a state S in the controller, we have therefore to ensure that all the sources in any graph associated to such a proposition be reachable by at least one transition in the controller. As observed, each state transition denotes a set of states, named transition postcondition semantics, such that the assemblage is in one of such states when the transition is completed. If t is a transition in the controller such that its ending state is S, by checking that post(t) [symbol] ε_{A}s, for any source SCC s of any directed graphs associated to vinc(S) ensures that all the subproposition of the state semantics are reachable.

### EXAMPLE 5

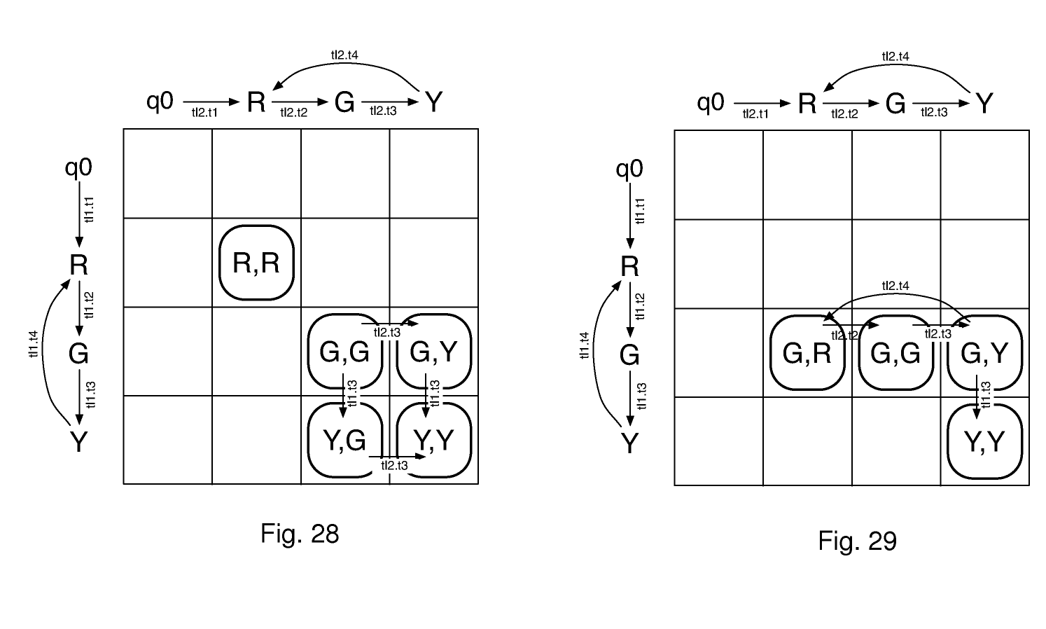

FIGS. 26 to 29 shows four state proposition (suppose they represent the semantics vinc(S) of state S in the controller) in the same layout of FIGS. 15 and 16 In FIG. 26 the proposition forms a single Strongly Connected Component (SCC). In this case, in order to ensure that any subproposition is reachable, we have simply to have one incoming transition covers at least one of the atomic propositions which make it such as, for example post(t)=(G, R) or post(t)=(G, G), and so on. In FIG. 27 it is instead shown a condition which consists of three different graphs, each one consisting of a single node, which is at the same time, the source of the graph. In order to ensure reachability, at least three transition {t₁, t₂, t₃} must reach T in case the condition is the semantics of such a state, each one being such that post(t₁)=(R, R), post(t₂)=(G, G) and post(t₃)=(Y, Y). The state proposition shown in FIG. 28 gives rise to two graphs, each consisting of a single SCC node. We show finally that the condition shown in FIG. 29 consists of a single graph with two nodes, where the SCC formed by the atomic propositions (G, R), (G, G) and (G, Y) is the source node.

### State Proposition Boolean Algebra

It is possible to express logical propositions, that is statements which are either true or false, with respect to the state of a single device in the assemblage as well as propositions with respect to the global state of the entire assemblage. The former kind of propositions will be named state machine propositions, while the latter will be named assemblage state propositions. They will be collectively referred to as state propositions.

State machine and assemblage propositions are employed both to formulate operational aspects of the controller (like transition guard conditions) as well as to express constraints on the global behavior of the assemblage during the process of verification.

State machine and assemblage propositions will be denoted by symbolic expressions, named state machine and assemblage expressions.

### EXAMPLE 6

Let “light1” be a traffic light device, whose behavior can be depicted by a state machine, which in turn can be found in state “Red”, “Yellow” or “Green”. Then “light1 is in state Red”, “light1 is in state Yellow” and “light1 is in state Green” are state machine propositions, which are true or false depending on the state of the device. Other state machine propositions can be built from simpler ones by ordinary propositional connectives, such as “light1 is in state Red and (or) light1 is in state Green”, as well as “light1 is not in state Red”.

### EXAMPLE 7

Let “light1” and “light2 ” be traffic light devices within an assemblage, such that each traffic light may be in state “Red”, “Yellow” or “Green”. Then “light1 is in state Red and light2 is in state Green” is an example of an assemblage state propositions, which is either true or false depending on the global state of the assemblage. Observe that any state machine proposition is also an assemblage proposition. Assemblage state propositions can be built from simpler ones by ordinary propositional connectives, such as “light1 is in state Red and light2 is in state Green (or) light2 is in state Red”.

### Syntax

Let d∈A be any state machine of the assemblage A. We define basic state machine expressions the union of constant and atomic state machine expressions, defined as:
1. none₌^{d} and any₌^{d} are state machine expression, which are said constant state machine expressions;
2. If S∈Q_{d} is any state of the state machine d, then S₌^{d} is a state machine expression, which is said atomic state machine expression.

### EXAMPLE 8

Let “light1” and “light2” be traffic light devices within an assemblage, such that each traffic light may be in state “Red”, “Yellow” or “Green”. Constant state machine expression any₌^{light1} denotes the state proposition which always holds, that is the proposition that “says” that device “light1” may be found in state “Red”, “Yellow” or “Green”. Conversely, constant device expression none₌^{light1} denote the state proposition which never holds. In other words, in “any state of the world”, that is in any global state of the assemblage, the first proposition is always true and the latter is always false.

### EXAMPLE 9

Let “light1” and “light2” be the traffic light devices within the assemblage of the example above. Then examples of atomic expressions are Red₌^{light1}, Red₌^{light2} and Green₌^{light1}, which denote, respectively, the propositions which hold, respectively, when traffic light “light1” is in state “Red”, when traffic light “light2” is in state “Red” and when traffic light “light1” is in state “Green”.

Assemblage expressions

Assemblage expressions are built starting from state machine expressions and special assemblage constant expressions, which are combined, by means of the operators ⊙, ⊕ and [symbol] into more complex assemblage expressions.

1. Any state machine expression is also an assemblage expressions;

2. If A is a device assemblage, then ANY_{A} and NONE_{A} are assemblage expressions, named assemblage constant expressions;

3. If e₁,e₂ are assemblage expressions, then e₁⊙e₂, e₁⊕e₂ and [symbol] e₁ are assemblage expressions, named assemblage compound expressions.

If e₁ and e₂ are expressions which denote state propositions, then the compound state expression e₁⊙e₂ denotes the conjunction of the two state propositions, that is the state proposition that holds when both the original state propositions hold.

In the same way, the expression e₁⊕e₂ denotes the disjunction of the two state propositions, that is the state proposition that holds when at least one of the original state propositions holds.

Finally, if e is an expression which denotes a state proposition, then the expression [symbol] e denotes correspondingly the negation of the state proposition, that is the proposition which does not hold iff the original proposition holds.

### EXAMPLE 10

Let e₁ be the expression Red₌^{light1}. Then e₁ denotes the state proposition which holds if and only if the device “light1” within an assemblage is in the state “Red”. If, moreover, e₂ is the expression Green₌^{light2}, then the expression Red₌^{light1}⊙Green₌^{light2} denotes the compound state proposition which holds iff device “light1” is in state “Red” and device “light2” is in state “Green”. Similarly the expression Red₌^{light1}⊕Green₌^{light2} denotes the compound state proposition which holds iff either device “light1” is in state “Red” or device “light2” is in state “Green”. Expression [symbol] Red₌^{light1} denotes finally the proposition which does not hold if device “light1” is in state “Red” and holds in all the other states.

### State Machine Expression Semantics

Given any state machine d∈A, and given any state q in which state machine d can be found, there exists a method for telling whether the proposition denoted by any device expression holds or does not hold.

There exists indeed a boolean valued function [[e]]_{boot}:Q_{d}→{true,false}, where Q_{d} is the set of states of the device, which assigns a truth value to any state machine expression e depending on the current state of the state machine. Such a boolean valued function represents the boolean semantics of device expressions and is recursively defined as follows:

For any device d∈A and for any choice of states q,S∈Q_{d}:

1. Constant state machine expressions:

[[none₌^{c}]]_{boot}(q)=true and [[any₌^{c}]]_{boot}(q)=false for any q∈Q_{c}

2. Atomic state machine expressions:

[[S₌^{c}]]_{boot}(q) is true if and only if q=S.

### Assemblage Expression Semantics

The semantics of an assemblage expression e is a boolean valued function [[e]]_{boot}:Q_{A}→{true,false}, where Q_{A} is the set of global states of the assemblage A, which assigns a truth value to any assemblage expression e depending on the global states of the assemblage. Such a boolean valued function represents the boolean semantics of state machine expressions and is recursively defined as follows:

1. if e is a state machine expression then: [[e]]_{boot}(q)=[[e]]_{boot}(q), where q is the component of the global state q corresponding to the state machine to which expression e is referred to;

2. [[S₌^{c}⊙T₌^{c}]]_{boot}(q)=false if S≠T, where c is any state machine of the assemblage;

3. [[e₁⊙e₂]]_{boot}(q)=[[e₁]]_{boot}(q) [symbol] e₂]]_{boot}(q) otherwise;

4. [[e₁⊕e₂]]_{boot}(q)=[[e₁]]_{boot}(q) [symbol] [[e₂]]_{boot}(q)

[symbol] e₁]]_{boot}(q) is true iff[[e₁]]_{boot}(q) is false;

where [symbol] and [symbol] are the usual boolean logical operators.

It may be observed that:
the semantics of the assemblage expression consisting of a single state machine expression (Rule 1) corresponds to the value of the semantics for such device expression, as defined in State machine expression semantics; in other words the semantics of device expressions is embedded within the semantics of assemblage expressions;
the semantics of the meet (⊙) operator between two atomic device expressions is given by two different cases.
   Rule 2 applies in the case in which both operands are atomic state machine expressions and the two expressions are referred to distinct states of the same device: it should be noted that it evaluates to false independently of the current state of the device, since the device may be found, at any time, in state S or in state T, but not in both;
   Rule 3 applies in all the other cases.

### The Boolean Algebra of Assemblage Expressions

It may be shown that the set of assemblage expressions form a Boolean Algebra, and as such it enjoys the related theorems. By analogy, we name the three operators as their boolean algebra counterparts, that is conjunction (⊙), disjunction (⊕) and negation [symbol] . We define also a minimal and a maximal element, respectively given by the expressions NONE_{A} and ANY_{A}.

### Containment Relationship Among Assemblage Expressions

We define a containment relationship among assemblage expressions, written as [symbol] ε_{A}, as follows: for any e₁,e₂∈ε_{A}, we say that e₁ is contained within e₂, in symbols e₁ [symbol] ε_{A} e₂ iff e₁⊙e₂=e₁ or iff e₁⊕e₂=e₂. We also define ad equivalence relationship ≡_{ε}_{_{A}} among state proposition by saying that a≡_{ε}_{_{A}} b iff a [symbol] _{ε}_{_{A}} b and b [symbol] _{ε}_{_{A}} a.

Deciding whether any assemblage expression is contained within any other any assemblage expression will be carried out by:
1. transforming both assemblage expressions into the equivalent normal form called sum of products (see the paragraph Sum of products here below), consisting of the join, named sum, of a finite number of special assemblage expressions named products, consisting in turn of a fixed number of device expressions;
2. comparing such sums of products by the algorithm in paragraph Containment among sums of products (see below), which in turn relies on the comparability among products of paragraph Containment among products (see below), which in turn relies on the comparability among device expressions of paragraph Containment among state machine expression (see below).

### Transformation of a State Proposition Induced by a State Transition

Given an assemblage state proposition p and given a state transition t in a component c of the assemblage A, we say that p is transformed by transition t of component c into the state proposition p′ after the only transition t happened, in symbols p′=transf(p, c, t). State proposition p′ is the state proposition which means “the assemblage was in state p and the state transition t happened”.

### Transformation of a State Proposition Induced by an Assemblage Event

Given an assemblage state proposition p and given a transition request e directed towards a component c of the assemblage, namely, a command c.e, we say that, once such a transition request has been successfully accomplished, the assemblage is found in a state transfE (p, c.e). In general there are different transitions which are labelled by the same input event e in component c; let T be the set of such transitions. We define:

$$transfE ( p , c . e ) = {⊕}_{t ∈ T} transf ( p , c , t )$$

where T is the set of transitions which are triggerable by event e in component c, in symbols T=trigger⁻¹(e).

### Transformation of a State Proposition Induced by a List of Actions

Let l be a list of actions, let [symbol] , according to the usual notation be the empty list, let head(l) be the first element of the list and let tail(l) be the list containing the remaining elements when head(l) is removed from l. Then the transformation induced by l on an assemblage state proposition p is given by transfL(p,l), which is computed recursively as follows:
1. if l= [symbol] , i.e, l is empty, then transfL(p, [symbol] )=p;
2. if head(l)=c.e , i.e, the trigger is an assemblage event, then transfL(p,l)=transfL(transfE(p,c.e), tail(l));
3. if head(l)=c.t , i.e, the trigger is an assemblage transition, then transfL(p,l)=transfL(transf(p,c,t), tail(l));
   that is, the empty list induces no transformation at all, the list which has at least one element induces a transformation on the state proposition depending on whether the command is an assemblage event or an assemblage transition.

### Sum of Products

Let A={m₁,m₂, . . . m_{N}} be an assemblage of state machines. A sum of products is a canonical form which is given by the join (that is, the OR of the algebra of state propositions) of a finite number of terms πᵢ, called products:

s=π₁⊕π₂⊕. . . ⊕π_{M}

where each product

π₁=b₁(m₁)⊙b₂(m₂)⊙b_{N}(m_{N})

is the meet (that is, the AND of the algebra of state propositions) of exactly N state machine propositions bᵢ(mᵢ), which is a basic state machine proposition related to state machine mᵢ∈A.

Sums of products are a canonical form of the algebra of state propositions. A sum of product is a special expression which denotes a state proposition. An effective method for transforming any state expression into a sop expression is described in paragraph Containment Among Products (see below); in the paragraph The Boolean Algebra of Sum of Products (see below) it is observed that sum of products form a boolean algebra themselves.

It is possible moreover to describe effective algorithms for computing basic operations in the algebra of sum of products (sop algebra) as well as to decide whether one expression is contained within another. It is therefore possible to compute any operation or make any comparison among state propositions by:
1. first transforming the operand state propositions into their equivalent sop normal form by the Algorithm in paragraph Containment Among Products;
2. applying the corresponding computable operation or comparison operator of the sop algebra to the sop operands.

### EXAMPLE 11

Let “light1” and “light2” be traffic light devices within an assemblage, such that each traffic light may be in state “Red”, “Yellow” or “Green”. It is then possible to write, among the others, the following products:

π₁=Red₌^{light1}⊙Red₌^{light2};

π₂=Red₌^{light1}⊙Green₌^{light2};

π₃=Red₌^{light1}⊙any₌^{light2};

### Notation

In order to improve readability:
1. we enclose the operands making a sum within braces and separate them by commas: we write thus s={π₁,π₂, . . . , π_{M}} in place of s=π₁⊕π₂⊕. . . ⊕π_{M}; we also say that the sum s “contains” products π₁, π₂ and so on;
2. we enclose the operands making a product within square brackets and separate them by commas: we write thus [Red₌^{light1}, Red₌^{light2}] in place of Red₌^{light1}⊙Red₌^{light2};
3. we omit constant device expressions of the kind any₌^{d}: we write thus [Red₌^{light 1}] in place of Red₌^{light1}⊙any₌^{light2}.
4. the term “sum of products” will be shortened either to simply “sum” or to the acronym SOP (Sum Of Products) or “sop”; we will speak also of “sop normal form” when referring to sop expressions.

Finally, products which are equivalent to the empty state proposition NONE_{A} can be omitted from a sum s, yielding a sum s′ which can be easily proven equivalent to the original one.

### EXAMPLE 12

The products of the example 11 above may then be written as:
π₁=[Red₌^{light1}, Red₌^{light2}];
π₂=[Red₌^{light1}, Green₌^{light2}]
π₃=[Red₌^{light1}]

A sum containing the three products above then may be written as
{[Red₌^{light1}, Red₌^{light2}],[Red₌^{light1}, Green₌^{light2}],[Red₌^{light1}]}

### The Boolean Algebra of Sum of Products

Sum of products form a Boolean algebra which is isomorphic to the algebra of state propositions. It can be observed that:

1. for any operator of the algebra of state propositions there exists a correspondent operator in the algebra of sum of products:
(a) meet operator ⊙′, described in paragraph Meet Among Sum of Products (see below) and used to compute the intersection of two sums;
(b) join operator ⊕′, described in paragraph Join Among Sum of Products (see below), used to compute the union of two sums;
(c) complement operator [symbol] , described in paragraph Complement of a Sum of Products (see below), used to compute the complement of a sum;

2. there exist two special sums of products which act as the zero and unity elements of the algebra:
(a) an empty sum s of products denotes the zero value of the algebra of assemblage state propositions associated with assemblage A, that is s≡ε_{A}NONE_{A}. We use therefore the empty sum { } in order to denote such value;
(b) different sums s may denote the unity value of the algebra of state propositions associated with assemblage A, that is, for any of such sums, s≡ε_{A}ANY_{A}.
   We refer collectively to such equivalence class by introducing a special sum symbol, that is {ANY_{A}}.
   Algorithm for Transforming State Propositions into Sum of Products: sop

It is possible to transform any assemblage expression e denoting a state proposition into a sum of products SOp(e) by the following recursive algorithm:

Algorithm 3 computes the sum of products corresponding to any assemblage expression e by recursive calls to itself (SOp(e), Algorithm 3) as well as by calls to Algorithms which calculate the meet (meetSums, Algorithm 6), the join (joinSums, Algorithm 5) and the complement (complementSum, Algorithm 7) of sums.

Algorithm 3 works by assuming that the sum of products corresponding to the meet of two expressions e₁, e₂ is the meet of the sums of the two operand expressions e₁, e₂; the sum of products corresponding to the join of two expressions e₁, e₂ is the join of the sums of the two operand expressions e₁, e₂ and finally the sum of products corresponding to the complement of an expressions e is the complement of the sum of the operand expression e. The base case is given by the assemblage expression which consists only of a state machine expression d about component machine m: in this case sop(d) returns a sum {π_{d}} containing a single product π_{d}, which is built as a meet of the state machine expression d and of a constant state machine expression any₌^{c} for any other component c different from m.

Algorithm 3: sop(e) Sum of Products Generation Algorithm

| | |
|---|---|
| input : | An assemblage expression e of the form e = e₁⊕e₂, |
| | e = e₁⊙e₂ or e = [symbol] e₁ or e=d, where d is a state machine |
| | expression |

```
output: A sum of products
if e = e₁⊙e₂ then
    return: meetSums(sop(e₁), sop(e₂));
end
if e = e₁⊕e₂ then
    return: joinSums(sop(e₁), sop(e₂));
end
if e = [symbol]  e₁ then
    return: complementSum(e₁);
end
if e=d then
    return: {π_{d}};
end
```

### EXAMPLE 13

Suppose we want to transform the compound expression

[symbol]

(Red^{tI1}⊙(Green₌^{TI1}⊕Red₌^{tI2}))

into a sum of products. Then:

1. We take the complement of the sum obtained by transforming the expression [symbol] (Red₌^{tI1}⊙(Green₌^{tI1}⊕Red₌^{tI2})) into a sum (see step 2) below); let such a sum be s₁;

2. transforming the expression Red₌^{tI1}⊙(Green₌^{tI1}⊕Red₌^{TI2}) into a sum involves transforming the operands Red₌^{TI1} and (Green₌^{tI1}⊕Red₌^{tI2}) into the corresponding sums and then taking their intersection (see steps 3 and 4 below): let such a sum be s₂;

3. the expression Red₌^{tI1} is a device expressions and then it is transformed into the sum s₃={[Red₌^{tI1}]}

4 . transforming the expression Green₌^{tI1}⊕Red₌^{tI2} into a sum, requires to transform the operands Green₌^{tI1} and Red₌^{tI2} into the corresponding sums and then taking their union (see steps 5 and 6 below) : let such a sum be s₄;

5. the expression Green₌^{tI1} is a device expressions and then itnsformed into the sum s₅={[Green₌^{TI1}]};

6. the expression Red₌^{tI2} is a device expressions and then it is transformed into the sum s₆={[Red₌^{tI2}]};

We have therefore that
s₄=s₅⊙′s₆={[Green₌^{TI1}],[Red₌^{tI2}]}
s₂=s₃⊙′s₄={[Red₌^{tI1}]}⊙′{[Green₌^{tI1}],[Red₌^{tI2}]}

We then take the meet of the product in the first sum and the first product of the second sum
π₁=[Red₌^{tI1}]⊙″[Green₌^{TI1}]=[Red₌^{tI1},Green₌^{tI1}]
   and we then take the meet of the product in the first sum and the second product of the second sum π₂=[Red₌^{tI1}]⊙″[Red₌^{tI2}]=[Red₌^{tI1}, Red₌^{tI2}]

Sum s₂ will contain only product π₂ since product π₁ denotes the empty state proposition: s₂={[Red₌^{tI1},Red₌^{tI2}]}

Finally: s₁= [symbol] ′s₂={[Green₌^{tI2}],[Green₌^{tI1}],[Yellow₌^{tI2}],[Yellow₌^{tI1}]}

### Addition of a Product to a Sum of Products: AddProductToSum

Given a sum s and a product π′ we want to obtain the sum s′ such that s′ denotes the state proposition which is equivalent to the state proposition s⊕π′. See Algorithm 4.

Algorithm 4: addProductToSum (s,π′)

| | |
|---|---|
| input | : A sum of product s and a product π |
| output | : A sum of products s′ |

```
if s = { } then
    return: s′ = {π′};
end
if head(s) [symbol]  ε_{A}π′ then
    return: s′ = addProductToSum (tail (s), π′);
end
if π [symbol]  ε_{A}head(s) then
    return: s′ = s;
end
if π′ [symbol]  head(s) and head(s) [symbol]  π′ then
    return: s′ = joinSums (s, {π′}) ;
end
```

### Join Among Sums of Products: JoinSums

The products in the two sums are added sequentially, by Algorithm 4, to a sum s′ initially empty. See Algorithm 5.

Algorithm 5: joinSums(s₁,s₂)

```
input: Two sum of products s₁ and s₂
output: A sum of products s
s′ = { };
foreach π₁ ε s₁ do
    s′ = addProductTo Sum(s′,πᵢ);
end
foreach πⱼ ε s₂ do
    s′ = addProductTo Sum(s′,πⱼ);
end
return: s′;
```

### Meet Among Sums of Products: MeetSums

For any pair of products in the two sum a new product is created, through Algorithm 9, then such product is added, by Algorithm 4, to a sum s initially empty. See Algorithm 6.

Algorithm 6: meetSums(s₁, s₂) Algorithm

```
input: Two sum of products s₁ and s₂
output: A sum of products s
s = { };
foreach πⱼ ε s₁
    foreach πⱼ ε s₂ do
        π = meetProducts(πᵢ,πⱼ);
        s = addProductTo Sum(s,π)
    end
end
return: s;
```

### Complement of a Sum of Products: ComplementSum

For each product πᵢ in sum s we compute the sum s which denotes the negation of the product through Algorithm 10 and add each product πⱼ in s to the sum s′ through Algorithm 4. See Algorithm 7.

Algorithm 7: complementSum(s₁)

```
input : A sum of products s₁
output : A sum of products s′
s′ = { };
foreach πᵢ ε s₁ do
    s = complementProduct(πᵢ);
    foreach πᵢ ε s do
    S′ = addProductTo Sum(s′,πⱼ);
    end
end
return: s′;
```

### Containment Among Sums of Products: ContainmentAmongSums

We compare for containment each product πᵢ in the first sum with each product πⱼ in the second sum through Algorithm 11. It returns true iff any comparison for containment among products πᵢ and πⱼ is true. See Algorithm 8.

Algorithm 8: containmentAmongSums(s₁,s₂)

```
input: Two sums of products s₁,s₂
output: A boolean value
foreach πᵢ ε s₁ do
    foreach πⱼ ε s₁ do
        if containmentAmongProducts(πᵢ,πⱼ) = false then
            return: false;
        end
    end
end
return: true;
```

### Meet Among Products: MeetProducts

Let bₘ(π) be the operand of a product which is the state machine proposition related to state machine m, given an assemblage A. The meet of two products is then given by the product which has the state machine proposition given by the meet of the two state propositions related to state machine m in the two operand products. See Algorithm 9.

Algorithm 9: meetProducts(π₁,π₂)

input: Two products π₁ and π₂
output: A product π
π = any₌^{m};
foreach m ε A do
bₘ(π) = meetAmongStateMachinePropositions(bₘ(π₁),bₘ(π₂));
end
return: π;

### Complement of a Product: ComplementProduct

See Algorithm 10.

Algorithm 10: complementProduct(π₁,π₂)

```
input: A product π
output: A sum s
s = { };
foreach m ε A do
    if bₘ(π) = any₌^{m} then
        return: s = { };
    endif
    else if bₘ(π) = none₌^{m}then
        return: s = {ANY_{A}};
    endif
    else if bₘ(π) = T₌^{m} then
        π = ANY_{A};
        foreach S ε Qₘ do
            if S ≠ T then
                bₘ(π) = S₌^{m};
            endif
        end
        s = addProductTo Sum(s,π);
    endif
end
return: s;
```

### EXAMPLE 14

Let π₁ Red₌^{light1}⊙Green₌^{light2}. Its negation [symbol] π₁ is then computed by taking the sum resulting from the negation of the basic device expressions Red₌^{light1} and Green₌^{light2}. In the former case we have that sₗ=Yellow₌^{light1}⊕Green₌^{light1}, while the latter results in the sum s₂=Yellow₌^{light2}⊕Red₌^{light2}. The final sum is then given by s=s₁⊕s₂=Yellow₌^{light1}⊕Green₌^{light1}⊕Yellow₌^{light2}⊕Red₌^{light2}.

### Containment Among Products: ContainmentAmongProducts

See Algorithm 11.

Algorithm 11: containmentAmongProducts(π₁,π₂)

```
input: Two sums of products π₁,π₂
output: A boolean value
foreach m ε A
    if containmentAmongStateMachinePropositions(bₘ(π₁),bₘ(π₂)) =
    false;
    then
        return: false;
    end
end
return: true;
```

### Transformation of a Product: TransformStateMachineProposition

We take each state machine expression in the product and we transform it . The result is a sum. Let π₁=⊙_{m∈A}b₁(m) where b₁(m) is the basic state machine expression corresponding to the component m of the assemblage A. Then, π₁ is transformed by the transition t of component c into the sum s as follows : let s_{c} be the sum corresponding to the transformation of the state machine expression b₁(c) induced by transition t of component c. Let s_{c}=⊕_{i=1 . . . N}πᵢ. Then the transformation is given by the sum s_{c}=⊕_{i=1 . . . N}π′ᵢ where each product π′ᵢ=⊙_{m∈A}b′(m) is obtained by the corresponding product πᵢ=⊙_{m∈A}b(m) of s_{c} by the rules: b′(m)=b(m) if c=m and b′(m)=b₁(m) if c≠m.

### Intersection Among State Machine Expressions

The algorithm is expressed in tabular form as shown below; p and q are distinct states belonging to state machine having rolename r.

| | | | | |
|---|---|---|---|---|
| ⊙ ′′′ | none₌^{r} | p₌^{r} | q₌^{r} | any₌^{r} |
| none₌^{r} | none₌^{r} | none₌^{r} | none₌^{r} | none₌^{r} |
| p₌^{r} | none₌^{r} | p₌^{r} | none₌^{r} | p₌^{r} |
| q₌^{r} | none₌^{r} | none₌^{r} | q₌^{r} | q₌^{r} |
| any₌^{r} | none₌^{r} | p₌^{r} | q₌^{r} | any₌^{r} |

### Containment Among State Machine Expressions

The algorithm is expressed in tabular form as shown below; p and q are distinct states belonging to state machine having rolename r.

| | | | | |
|---|---|---|---|---|
| ≦′′′ε_{A} | none₌^{r} | p₌^{r} | q₌^{r} | any₌^{r} |
| none₌^{r} | true | false | false | false |
| p₌^{r} | false | true | false | true |
| q₌^{r} | false | false | true | true |
| any₌^{r} | false | false | false | true |

### Communication and Synchronization

The control model provides two very general models of synchrony.
1. state machines operate through an internal, never ending cycle, which iterates a basic computation step. During a computation step, signals sent to the machine are evaluated, and one, if any, state transition is chosen for execution. A state transition execution consists in computing a new current state and in sending out signals directed to other state machines;
2. state machines communicate through some communication medium, which again operates through one or more never ending cycles. Such cycles iterate basic communication computations, which consist, essentially, in delivering signals from one machine to the another.

3.

In the asynchronous model each machine is driven by a separate thread (by using a software oriented language) or a separate processor (by using an hardware oriented language). The communication medium is again driven by one or more (different) threads or processors. The three main entities of the control model (controller and controlled machines, communication medium) are therefore behaviorally independent and synchronize only through communication ports. A communication port is a block of memory which is shared among the different processes. The processes read and write control signals by a typical producer consumer pattern of execution. To prevent processes from reading or writing the shared data at the same time, one or more mutex or read-write locks are employed. Finally, the shared block of memory can be structured as a FIFO list, in order to have the producer not to stop in case a new control signal is produced before a previously produced control message has been consumed.

In the synchronous model both the controller and the controlled state machines, as well as the communication medium, are driven by a unique thread or processor. By using the software oriented language, that means that while executing its internal cycle, the controller state machine stops and starts executing both computations of the communication medium as well as, sequentially, the internal cycle of each controlled machine. By using an hardware oriented language, either the controlled machines are part of the processor and execute in its main cycle, or some sort of time driven, or master-slave synchronization is implemented through different processors.

The control model will be able not only to provide both kinds of synchronization, but also to host a mix of them. In other words, given a controller state machine and a set of controlled state machines, it may be the case that some machines in the set are controlled through the asynchronous model, and the others through the synchronous one. As an example, the same computer processor may control other machines asynchronously through a field bus and, at the same time control other internal state machines synchronously, like timers or adders, by the internal motherboard communication bus.

Finally, a simple, yet abstract, way of differentiating the two models independently of implementation issues, consist in contrasting them by comparing execution times:
Asynchronous behavior: each request of behavior is served within a given delay, due to the internal work of the controlled machine and to the propagation time taken by the request in travelling from a controller to a controlled machine; in the same way, notification of behavior takes some time to travel back from the controlled to the controller machine.
Synchronous behavior: each request of behavior is served instantaneously.

### Current-State Array

Each state machine is equipped with an array of symbols, each denoting the currently known state of a component machine of the assemblage under control of the machine.

Such an array of symbol is kept up to date with the current state of the component machines as part of the workflow of the state machine and of the communication medium, by means of the messages exchanged, as explained below in paragraph Current State Array and Incoming Event Computation (see below).

### Incoming Internal Event

Each state machine is equipped with a variable holding the event symbol (if any) associated to the last transition which took place in a component machine. The content of such variable is kept up to date as part of the workflow of the state machine and of the communication medium, by means of the messages exchanged, as explained below in paragraph Current State Array and Incoming Event Computation.

### Incoming Internal Transition Symbol

Each state machine is equipped with a variable, which coincides with the CMO port of paragraph CMOP Communication Medium Output Port (see below), holding the symbol which denotes the last transition which happened within the assemblage in the form of a TCIC signal (see below paragraph TCIC—Transition Completed in Component).

### Control Signals

Control signals are used in order to coordinate the joint behavior of the assemblage and of the controller. They are generated by either one of the assemblage components or by the controller, and processed by the communication medium.

### TC—Transition Completed

A transition completed signal is generated by a component state machine in order to notify that a specific transition happened within the machine. It consists of the bare transition identifier and is sent to the communication medium.

### TCIC—Transition Completed in Component

A TCIC signal identifies univocally a transition within the whole assemblage of components. A TCIC signal is generated by the communication medium as part of its workaround: once a TC signal t generated by a state machine c is received by the communication medium, the TCIC signal (c, t) is sent to the controller.

### ERIC—Event Required in Component

This signal, which will be referred to as command, is generated by the controller in order to ask a specific component state machine to undertake some state transition labelled by a specific input event. A command consists of the identifier of the machine plus an event symbol belonging to the machine input events. For example, by sending the command (c, e) the controller asks the state machine c to undertake a state transition, if any, departing from the current state of c and labeled by the input event e. Such a transition t is such that event (t)=e.

### Communication Ports

We distinguish the different kinds of ports by the typology of message exchanged and by the producer and the consumer of such signals.

### COP Component Output Port.

This port is placed between a component state machine and the communication medium and hosts a queue of TC signals, which are produced by the component state machine and consumed by the communication medium.

### CMOP Communication Medium Output Port.

This port is placed between the communication medium and the controller and hosts a queue of TCIC signals, which are produced by the communication medium and consumed by the controller.

### CIP Component Input Port.

This port is placed between the communication medium and the component state machine and hosts a queue of event signals, which are produced by the communication medium and consumed by the component state machine.

### CMIP Communication Medium Input Port.

This port is placed between the communication medium and the controller and hosts a queue of ERIC signals, which are produced by the controller and consumed by the communication medium.

### Communication Architecture

By communication architecture we mean the global arrangement of component and controller state machine and of the communication medium by means of communication ports.

A typical communication architecture involving an assemblage of component state machines A={C₁,C₂, . . . Cₙ} and a controller state machine C is shown in FIG. 30. Each component state machine is connected to the communication medium M by two ports, respectively a component input (CIP) and output (COP) port. The communication medium M is on its turn connected to the controller C by two ports, respectively a communication medium input (CMI) and output (CMO) port.

It is also possible to have a multilevel arrangement of component and controller state machines, since each controller can be attached to another communication medium as if it were a component on its turn. A typical case of multilevel arrangement is shown in FIG. 31, where two assemblages, namely A₁={C₁₁,C₁₂, . . . , C_{1N}} and A₂={C₂₁,C₂₂, . . . , C_{2N}} are controlled, respectively, by the controller state machines C₁ and C₂, through the communication media M₁ and M₂ and the respective communication ports.

Controller state machines Cₗ and C₂ are moreover attached on their turn to a third communication medium M₃, and as such they become component of a third assemblage A₃={C₁,C₂}. The communication medium M₃ is finally connected to the controller C by a communication medium input (CMI) and output (CMO) port.

It is possible to observe that state machines may be grouped into different typologies, depending on the control they exercise upon other machines or, vice versa, the control other machines exercise upon them:
1. state machines which are simply controlled, like the state machines in the assemblages A₁ and A₂;
2. state machine which exercise control and are at the same time controlled, like the state machines C₁ and C₂ making the assemblage A₃;
3. state machines which simply exercise control other state machines like state machine C.

### Communication Medium Workflow

The communication between the controller and the controlled state machines happens through a communication medium which is an operating entity whose aim is to bring control signals from the components to the controller and vice versa. We present an abstract operational model of the behavior (whose main tasks are depicted in FIGS. 32 and 33) which may be implemented in a variety of different ways upon different communication technologies.
controller-component communication: this task (depicted in FIG. 32) is aimed at notifying the controller that a transition happened within a specific controlled machine c of the assemblage. The component machine does not contain any information regarding neither the existence of any controller nor that the state machine itself is identified by c within the assemblage. It therefore simply emits a transition completed (TC) signal towards the communication medium, which has the duty of completing it with the additional information that such a signal was produced by c. The communication medium therefore wraps the TC signal within a TCIC signal, which indeed embeds the additional information about the source of the TC signal. The TCIC is finally dispatched to the controller, which then updates its knowledge about both the current state of c and the output event optionally emitted;
component-controller communication: this task (depicted in FIG. 33) is aimed at notifying the component c that an action, say c.e has been sent to it from the controller. This time the controller is aware of the existence of component c, therefore the communication medium simply unwraps the ERIC signal by using the destination part to deliver the message to the component and by depositing the event part to the component input port (CI) for being consumed and processed.

### Current State Array and Incoming Event Computation

When a TRIC signal c.t is dispatched to the state machine, the state machine updates the array of the current states and the incoming output event variable, as shown in FIG. 34:
1. the last state observed in component c is known by the current array entry;
2. given the state transition identifier t it becomes possible to fetch the new current state of the component and to update such an array; we assume that a state machine acting as a controller for another state machine c is equipped with a description (say in tabular form) of the controlled machine;
3. in the same way it becomes possible to know the output event associated with the transition, and to update the incoming output event variable accordingly.

### State Transition Selection

Given the current state s of a state machine, the current state array, a current internal incoming event (if any), a current external incoming event (if any) and the array of current component states, we say that a (possibly empty) set of state transitions is selected for being executed iff for each state transition in such a set the following conditions are verified:
1. the transition has the state s as its departing state; and
2. the guard condition is satisfied; and
   (a) the internal incoming event matches the transition internal trigger (if any); Or
   (b) the external incoming event matches the transition external trigger (if any); or
   (c) the transition is automatic (it has neither an internal nor an external trigger);

### State Transition Execution

Given a state transition belonging to a state machine the state transition is executed when:
1. the target state of the state transition becomes the current state;
2. the actions in the action list which labels, if any, the state transition are sent to the communication medium input (CMI) port;
3. a transition completed (TC) signal is sent to the component output (CO) port.

### State Machine Behavior

The behavior of a state machine consists in performing an initialization phase, then in repeating indefinitely an execution cycle.

In the initialization phase:
1. it is requested that each component of the assemblage under control of the state machine (if any) communicates at least once its internal status and current event;

2. a subset of the automatic state transitions which have the initial state as initial state are selected for execution and the first transition in the subset is chosen for execution.

The execution cycle consists of the alternate fetch of signals coming from both the components and the controller and on the execution of either the transitions which have those signals as triggers or are automatic:
1. the component input port (CI) is looked up;
   (a) in case a transition completed in component

(TCIC) signal is present, it is fetched and removed from the port, then the current state array and the current event are updated;
(b) a set of transition are selected for execution;
(c) the first transition in the set of transition obtained at the previous point is chosen for execution;

2. the communication medium input (CMI) port is looked up;
(a) in case an input event signal is present, it is fetched and removed from the port;
(b) a set of transition are selected for execution;
(c) the first transition in the set of transition obtained at the previous point is chosen for execution.

1-27. (canceled)

28. A method for controlling a physical machine or an assemblage of physical machines for ensuring safety and liveness rules in a state based design of said physical machine or assemblage of physical machines, comprising the steps of associating at least one logical state to at least one physical state that said physical machine or assemblage of physical machines may assume, providing state constraints for said logical states, and checking that a physical state assumed by said physical machine or assemblage of physical machines is associated to a logical state complying with said state constraints.

29. A method according to claim 28, and further comprising the steps of moving said physical machine or assemblage of physical machines out of a physical state if said physical state is not associated to a logical state that complies with said state constraints, and forcing said physical machine or assemblage of physical machines to assume a physical state associated to a logical state that complies with said state constraints.

30. A method according to claim 28, wherein said state constraints comprise a set of logical states associated to physical states that said physical machine or assemblage of physical machines is allowed to assume.

31. A method according to claim 30, and further comprising the step of verifying whether each state of said set of logical states may be reached as a result of a transition starting from another logical state of said set of logical states.

32. A method according to claim 30, and further comprising the step of verifying that said physical machine or assemblage of physical machines is capable of reaching any physical state associated to a logical state of said set of logical states.

33. A method according to claim 30, and further comprising the step of verifying that each physical state assumed by said physical machine or assemblage of physical machines during a transition from an initial physical state to a final physical state is associated to a logical state of said set of logical states.

34. A method according to claim 28, and further comprising the step of associating to a physical machine a state machine that is a logical machine having logical states, each of which corresponds to at least one physical state of said physical machine.

35. A method according to claim 28, and further comprising the step of associating to an assemblage of physical machines an assemblage of state machines, said assemblage of state machines having logical states each of which corresponds to at least one physical state of said assemblage of physical machines.

36. A method according to claim 35, wherein each state machine of said assemblage of state machines is associated with a respective physical machine of said assemblage of physical machines, each logical state of each state machine corresponding to a physical state of the respective physical machine.

37. A method according to claim 34, wherein a state machine is associated to a respective physical machine by means of an interface, said interface comprising a sensor capable of converting a physical state of said physical machine into a logical state of said state machine and an actuator capable of converting logical commands of said state machine into physical commands acting on said physical machine.

38. A method according to claim 34, wherein said state constraints comprise a set of logical states that a state machine is allowed to assume.

39. A method according to claim 35, wherein said state constraints comprise a set of logical states that an assemblage of state machines is allowed to assume.

40. A method according to claim 35, wherein a state machine may act as a controller of another state machine or assemblage of state machines, or be controlled by another state machine or assemblage of state machines.

41. A method according to claim 40, wherein said state constraints comprise a set of logical states a state machine or an assemblage of state machines controlled by a controller may assume when said controller is in a given state.

42. A method according to claim 38, and further comprising the step of verifying whether a state machine is in a logical state complying with said constraints before a transition from said logical state to a second logical state occurs.

43. A method according to claim 42, and further comprising the step of verifying that said second logical state complies with said constraints.

44. A method according to claim 39, and further comprising the step of verifying whether an assemblage of state machines is in a logical state complying with said constraints before a transition from said logical state to a second logical state occurs.

45. A method according to claim 44, further comprising verifying that said second logical state complies with said constraints.

46. A method according to claim 42, wherein a transition from a logical state to said second logical state in said state machine is associated with a logical command that may be converted into a physical command for generating a physical transition in a physical machine associated with said state machine.

47. A method according to claim 44, wherein a transition from a logical state to said second logical state in said assemblage of state machines is associated with a logical command that may be converted into a physical command for generating a physical transition in an assemblage of physical machines associated with said assemblage of state machines.

48. A method according to claim 34, wherein a transition from a physical state to a second physical state in said physical machine generates a transition from a logical state to a second logical state in a state machine associated with said physical machine.

49. A method according to claim 48, wherein said state machine verifies whether said transition complies with said state constraints.

50. A method according to claim 49, wherein said state machine generates a logical command that may be converted into a physical command for forcing said physical machine to assume a physical state associated to a logical state of said state machine that complies with said state constraints, if said transition does not comply with said state constraints.

51. A method according to claim 35, wherein a transition from a physical state to a second physical state in said assemblage of physical machine generates a transition from a logical state to a second logical state in an assemblage of state machines associated with said assemblage physical machines.

52. A method according to claim 51, wherein said assemblage of state machines verifies whether said transition complies with said state constraints.

53. A method according to claim 52, wherein said assemblage of state machines generates a logical command that may be converted into a physical command for forcing said assemblage of physical machines to assume a physical state associated to a logical state of said assemblage of state machines that complies with said state constraints, if said transition does not comply with said state constraints.

54. A method according to claim 40, and further comprising the step verifying whether only one transition is activated by an external event, if there exist a plurality of transitions that may be activated by said external event under respective given conditions.
